(19) United States
(12) Patent Application Publication
(10) Pub. No.: US 2025/0354308 A1
(43) Pub. Date: Nov. 20, 2025

(54) COMPOSITIONS AND METHODS FOR NONWOVEN MATERIALS

(71) Applicant: Poly-Med, Inc., Anderson, SC (US)

(72) Inventors: Clayton J. Culbreath, Anderson, SC (US); Kenneth W. Clinkscales, Easley, SC (US); Michael Aaron Vaughn, Anderson, SC (US); Michael Scott Taylor, Anderson, SC (US); Seth Dylan McCullen, Anderson, SC (US); David M. Gravett, Anderson, SC (US)

(21) Appl. No.: 19/292,049

(22) Filed: Aug. 6, 2025

Related U.S. Application Data
(63) Continuation of application No. PCT/US2024/026184, filed on Apr. 25, 2024.
(60) Provisional application No. 63/461,631, filed on Apr. 25, 2023.

(51) Int. Cl. D04H 1/4382; C08G 63/08; D04H 1/435; D04H 1/728

(52) U.S. Cl. CPC D04H 1/43835; C08G 63/08; D04H 1/435; D04H 1/728; D10B 2331/041; D10B 2401/063; D10B 2509/00

(57) ABSTRACT

Disclosed herein are nonwoven materials, such as electrospun materials, that have one or more of the characteristics of softness, loftiness, particular pore sizes, little to no solvent retention, and mechanical and dimensional stability for use in implanted medical devices.

### CROSS-REFERENCE TO RELATED APPLICATIONS

This application is a continuation of International Application No. PCT/US2024/026184 filed Apr. 25, 2024, which claims the benefit of priority to U.S. Provisional Patent Application No. 63/461,631, filed Apr. 25, 2023, which is hereby incorporated herein in its entirety.

### BACKGROUND OF THE INVENTION

Synthetic absorbable polymers are routinely used as medical implants, scaffolds for tissue engineering and drug delivery devices. Since the emergence and acceptance of the absorbable suture VICRYL, available from Ethicon Inc., a subsidiary of Johnson and Johnson, significant work has been performed with absorbable polyesters due to their long industrial use history, well known degradation mechanism, non-toxic by-products, and availability in multiple FDA-approved medical devices.

Recently, the electrospinning method, using an electrical charge to draw very fine, typically on the micro or nano scale, fibers from a liquid, has generated significant interest in medical device applications as this process can produce micro-fibrous materials with a topography similar to the native extracellular matrix. Absorbable and non-absorbable electrospun materials are capable of mimicking the topography of the extracellular matrix due to their fibrous form, as well as providing an ideal substrate for biological interaction due to their enhanced surface area to volume ratio.

During the electrospinning process, a polymer is dissolved in solution and is metered at a controlled flow rate through a capillary or orifice. By applying a critical voltage to overcome the surface tension of the polymer solution (and with sufficient molecular chain entanglement in solution) fiber formation can occur. Application of a critical voltage induces a high charge density forming a Taylor cone, the cone observed in electrospinning, electrospraying and hydrodynamic spray processes from which a jet of charged material emanates above a threshold voltage, at the tip of the orifice.

Emerging from the Taylor cone, a rapid whipping instability, or fiber jet is formed moving at approximately 10 m/s from the orifice to a distanced collector or substrate. Due to the high velocity of the fiber jet, fiber formation occurs on the order of milliseconds due to the rapid evaporation of the solvent, inhibiting polymer crystallization. Typically, the ejected jets from the polymer solution is elongated more than 10,000 draw ratio in a time period of 0.05 seconds. This high elongation ratio is driven by the electric force induced whipping instability, and the polymer chains may remain in an elongated state after fiber solidification due to this high elongation and chain confinement within micron-sized fibers.

For semi-crystalline polymers, retarded crystallization is usually observed since fast solidification of the stretched polymer chains does not allow time to organize into suitable crystal regions, and is also inhibited by small fiber diameters. The formation process can also impart a significant amount of internal stresses into the resulting fibers. As a result of the highly elongated polymer chains within the fibers in an amorphous form, these materials can undergo both morphological and mechanical property changes when exposed to heat due to cold crystallization as well as stress relief via application of heat.

Electrospun materials are advantageous for a range of applications in the medical device field for tissue replacement, augmentation, drug delivery, among other applications. However, electrospun materials may be relatively unstable and may undergo crystallization due to their amorphous nature and highly elongated polymer chains residing within their polymeric fibers. Further, residual stresses are generated from the dynamic “whipping” process used to produce small-diameter fibers. As typical electrospun materials undergo thermal treatments/exposure, polymer crystallization can occur, distorting fiber topography, pore size, inducing shrinkage and altering mechanical properties. For instance, in the case of poly(lactic-co-glycolic) acid (“PGLA”) copolymers, such as VICRYL 90/10 PGLA, at temperatures of 37° C., shrinkage as high as 20% has been observed. This results in smaller constructs with significantly higher stiffness as well as loss of desirable chemical and mechanical properties.

What is needed in the art are improved electrospun materials. The following disclosure addresses this need.

### SUMMARY OF THE INVENTION

In accordance with the purposes of the disclosed compositions and methods, as embodied and broadly described herein, the disclosed subject matter relates to compositions and methods for making and using electrospun materials.

For example, disclosed herein are compositions and methods for making and using electrospun materials. Such disclosed materials may overcome limitations seen with prior non-woven materials, such as poor cell infiltration and migration, toxicity of residual solvents, low mechanical strength, and challenges in creating thick sheets. Disclosed compositions and methods comprise electrospun materials that have characteristics of at least thick sheets, softness, little to no residual solvent, mechanical strength adequate for many medical device and implantation applications, and/or porosity that encourage cell infiltration and migration.

For example, disclosed herein are electrospun materials and methods of making electrospun materials. In some examples, the electrospun materials can comprise polymeric fibers comprising at least glycolide and lactide monomers, having at least the characteristics of softness, loftiness, particular pore sizes, little to no solvent retention, and mechanical and dimensional stability for use in implanted medical devices.

For example, described herein are electrospun materials comprising two fiber populations wherein one fiber population comprises polymeric fibers of a block semi-crystalline copolymer comprising at least glycolide or lactide monomer residues and second fiber population wherein the semicrystalline polymer comprises a polyester, polyether ester, or polyester carbonate. In some examples, the electrospun construct meets the requirements of: all polymers used to prepare the first fiber population and the second fiber population have a glass transition temperature of ≤25° C.; a residual solvent of <2000 ppm; a tensile modulus of less than 30 MPa at room temperature; wettable when placed in water in under 5 sec; or a combination thereof.

In some examples, the electrospun material is a triblock polymer comprising of glycolide or lactide monomers that are less than 90% of the composition and greater than 55% of the composition.

In some examples, the material is a triblock polymer structure with an amorphous segment comprising of either trimethylene carbonate or caprolactone.

In some examples, the material is a triblock polymer structure with an amorphous segment comprises a glass transition temperature of less than 0° C.

In some examples, the material comprises a block copolymer of an amorphous segment (A), a semicrystalline endgraft (B), and an initiator (I) wherein the structure may be I-A-B and the initiator may be monofunctional, difunctional, trifunctional, and other multifunctional moieties.

In some examples, the material has a residual solvent less than 1000 ppm.

In some examples, the residual solvent is less than 2000 ppm.

In some examples, the material has a residual hexafluoro-2-propanol less than 1000 ppm.

In some examples, the material has a residual hexafluoro-2-propanol less than 2000 ppm.

In some examples, the material has a density of less than 350 kg/m³.

In some examples, the material has a deflection of ≥1° with a 50 mm sheet.

In some examples, the material has at least two fiber populations of a polyester or polyester carbonate.

In some examples, the material has at least two fiber populations wherein the second fiber population comprises polydioxanone.

In some examples, the material is a blend of polymers comprising polyester, polyester carbonates, polyethers, or combinations thereof.

In some examples, the material comprises at least one bioactive agent selected from the group consisting of anti-inflammatory agents, anesthetic agents, antineoplastic agents, antimicrobial agents, microbicidal agents, antithrombic agents, and cell growth-promoting agents.

In some examples, the material is a medical device or combinational product.

In some examples, the material is a bioabsorbable pouch.

Also disclosed herein are electrospun materials comprising polymeric fibers from a block copolymer of at least glycolide or lactide monomers. In some examples, the electrospun material comprises: a polymer glass transition temperature <25° C.; a residual solvent of <2000 ppm; a tensile modulus of less than 30 MPa at room temperature; or a combination thereof.

In some examples, the electrospun material is a triblock polymer comprising of glycolide or lactide monomers that are less than 90% of the composition and greater than 55% of the composition.

In some examples, the material is a triblock polymer structure with an amorphous segment comprising of either trimethylene carbonate or caprolactone.

In some examples, the material is a triblock polymer structure with an amorphous segment comprises a glass transition temperature of less than 0° C.

In some examples, the material has a glass transition temperature that is less than 25° C.

In some examples, the material comprise a block copolymer of an amorphous segment (A), a semicrystalline endgraft (B), and an initiator (I) wherein the structure may be I-A-B and the initiator may be monofunctional, difunctional, trifunctional, and other multifunctional moieties.

In some examples, the material has a residual solvent less than 1000 ppm.

In some examples, the material has a residual hexafluoro-2-propanol less than 1000 ppm.

In some examples, the material has a residual hexafluoro-2-propanol less than 2000 ppm.

In some examples, the material has a density of less than 350 kg/m³.

In some examples, the material has a deflection of ≥1° with a 50 mm sheet.

In some examples, the material has at least two fiber populations of a polyester or polyester carbonate.

In some examples, the material has at least two fiber populations wherein the second fiber population comprises polydioxanone.

In some examples, the material is a blend of polymers comprising polyester, polyester carbonates, polyethers, or combinations thereof.

In some examples, the material is wettable in water at room temperature in under 5 seconds.

In some examples, the material comprises at least one bioactive agent selected from the group consisting of anti-inflammatory agents, anesthetic agents, antineoplastic agents, antimicrobial agents, microbicidal agents, antithrombic agents, and cell growth-promoting agents.

In some examples, the material is a medical device or combinational product.

In some examples, the material is a bioabsorbable pouch.

Additional advantages will be set forth in part in the description that follows or may be learned by practice of the aspects described below. The advantages described below will be realized and attained by elements and combinations particularly pointed out in the appended claims. It is to be understood that both the foregoing general description and the following detailed description are exemplary and explanatory only and are not restrictive.

### BRIEF DESCRIPTION OF THE DRAWINGS

Exemplary features of the present disclosure, its nature and various advantages will be apparent from the accompanying drawings and the following detailed description of various embodiments. Non-limiting and non-exhaustive embodiments are described with reference to the accompanying drawings, wherein like labels or reference numbers refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings.

FIGS. 1A and 1B are photomicrographs of electrospun material made of MG5 copolymers, taken at different sites of the material.

FIGS. 2A and 2B are photomicrographs of electrospun material made of a first poly-axial copolymer (MG5) and a second polymer, PPD-3 (polydioxanone) polymer, taken at different sites of the material.

FIGS. 3A and 3B are photomicrographs of electrospun material made of a first polymer, poly-axial copolymer MG5, and a second copolymer, RD7, taken at different sites of the material.

FIGS. 4A and 4B are photomicrographs of electrospun material made of MG9 copolymers, taken at different sites of the material.

FIGS. 5A and 5B are photomicrographs of electrospun material made of a first copolymer, MX 1, and a second polymer, PPD-3, taken at different sites of the material.

FIGS. 6A and 6B are photomicrographs of electrospun material made of PPD-3 homopolymers, taken at different sites of the material.

FIGS. 7A and 7B are photomicrographs of electrospun material made of a first copolymer, MX 2, and a second polymer, PPD-3, taken at different sites of the material.

FIGS. 8A and 8B are photomicrographs of electrospun material made of a first copolymer, MX 2, and a second polymer, PPD-3, with an active agent added, taken at different sites of the material.

FIGS. 9A and 9B are photomicrographs of electrospun material made of RD-7 copolymers, taken at different sites of the material.

FIGS. 10A and 10B are photomicrographs of electrospun material made of MDP 3 copolymers, taken at different sites of the material.

FIGS. 11A and 11B are photomicrographs of electrospun material made of PCL homopolymers, taken at different sites of the material.

FIGS. 12A and 12B are photomicrographs of electrospun material made of PLA homopolymers, taken at different sites of the material.

FIGS. 13A and 13B are photomicrographs of electrospun material made of MG5, PPD3, and PEG.

FIG. 14. Electrospun fabric pouch in two layers with 0.5 cm welded seam.

FIG. 15. Electrospun layered structure formed with a 2 mm ultrasonically welded seam.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION

The methods and compositions described herein may be understood more readily by reference to the following detailed description of specific aspects of the disclosed subject matter and the Examples included therein.

Before the present methods and compositions are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, polymer and copolymer may be used interchangeably, and those of skill in the art can discern the meaning of each.

The term “(meth)acryl . . . ” includes “acryl . . . ,” “methacryl . . . ,” or mixtures thereof.

As utilized herein, the term “stiffness” is intended to have its conventional definition of a measurement of the resistance of an elastic body to deformation when a force is applied along a given degree of freedom. Likewise, as utilized herein, the terms “flexibility” and “elasticity” relate to the ability of a material to elastically deform when a force is applied along a given degree of freedom, but not necessarily plastically deform. In other situations, some plastic deformation may occur and the measurements provided herein may include the total deformation including both elastic and plastic. A material or structure is considered to be flexible as utilized herein when the material or structure deforms with application of force, but when the force is removed, the material returns to its original shape prior to the application of force, without the requirement of heat.

The present disclosure provides compositions and methods for making and using electrospun materials. Such disclosed electrospun non-woven fabrics overcome limitations found in previously known electrospun materials. Often with electrospinning polyester materials, there is a tradeoff in the materials selection process. For example, a particular polyester fiber composition for electrospinning may have higher strength and be capable of being spun into thicker sheets but it may be challenging to extract the residual solvent(s) from the resulting electrospun material and the resulting electrospun material may not exhibit thermal stability. Also, a particular polyester fiber composition may tend to produce stiffer non-woven fabrics (tensile modulus >50 MPa). Also known are polyester fiber compositions that are more flexible and easier to remove solvent residuals but cannot be electrospun into thick sheets, with the resulting electrospun material, e.g., fabric, exhibiting lower mechanical strength.

Previous work by D'Amato (D'Amato, Anthony R., et al. Electrospinning 2.1 (2018): 15-28.) indicated the challenges of solvent retention in electrospun sheets. Particularly, polyglycolide and polylactide-co-polycaprolactone scaffold had as much as 78,000 ppm and 54,000 ppm of residual HFIP solvent post spinning. In previous work by some of the present inventors, they have shown solvent removal to be challenging below 8,000 ppm under low vacuum (<5 torr) especially in high glycolide (≥90 wt. %) polymer formulations. In D'Amato's work, polyglycolide residual solvent only decreased to 39,000 ppm after 14 days at room conditions. In addition, D'Amato showed substantial increases in tensile modulus upon removal of solvent with up to 3 to 4 fold increases. This presents a unique challenge of designing materials that can have, and the present disclosure provides methods and compositions for materials with low residual solvent and low modulus after electrospinning.

Softness is a desired tactile characteristic of low residual solvent and low modulus after electrospinning an electrospun fabric, and is a subjective measure related to perceived compliance and handling of an electrospun fabric. There are several ways to analytically differentiate materials by aspects relating to softness. These include (1) a measure of fabric stiffness by cantilever bending angle, as detailed in ASTM D1388, (2) mechanical rigidity by tensile modulus, (3) friction, (4) fiber diameter, (5) hysteresis measures, and others known to those of skill in the art. One comparison for fabric softness is a relative measure, for example, panel testing. Another method for analytically comparing fabrics, a multi-dimensional assessment, has been developed to provide a tactile sensation measure, for example, a TSA unit manufactured by Emtec (Leipzig, Germany), incorporating sound analysis to determine roughness, sound analysis for in-plane stiffness, elasticity, and recovery.

A known challenge with nonwovens prepared by electrospinning is the development of structure thickness. By nature, electrospun nonwovens generate interconnected pancake-like pores, and during fabric creation, addition of fabric layers typically adds thickness in a logarithmic relationship; in other words, increasing material deposition does not linearly correlate with fabric thickness. This is thought to be a result of several factors, one of which is retention of solvent in deposited fibers (drying rate during fiber travel between the needle and collector, as well as during the dwell time on the collector during subsequent material deposition) and the compressibility of electrospun pores. Electrospinning compositions and processes used in electrospinning that can more closely approximate a linear relationship between fabric thickness and material deposition create a more repeatable process with increased consistency in nonwoven performance for a particular fabric composition. This approximate linear relationship in a fabric can be measured in terms of the ratio between fabric thickness and fabric area weight.

Fabrics with increased porosity, interconnectedness, as well as loftier pores, such as those disclosed herein, are beneficial for a number of applications. Previously known electrospun fabrics have shown capability as tissue engineering scaffolds due to the potential to create fibers on the size scale of extracellular matrix fibers; however, such electrospun fabrics have little, if any, loft and have flat pores that limit cellular penetration. In contrast, compositions and fabrics disclosed herein may have increased depth of cell penetration due to higher loft pores. Higher loft pore structures may also allow increased interstitial channeling for vascularization and material transport in an implanted tissue scaffold. In an application, loftier pore structures in an electrospun material may provide improved fluid conduction and absorption for treatment of burn wounds and diabetic foot ulcers. This increased pore volume and loft may also allow increased volume for delivery of one or more active agents and carrier materials such as core-shell polymeric microspheres.

In fiber terminology, loft may refer to the structural ratio of fiber to air. A high-loft fiber structure (such as yarn) or fabric contains more air than fiber. A higher-loft fiber structure or fabric may be much thicker than low-loft fabrics/fiber structures, in which the individual filaments are compacted, even at the same fabric weight (grams per square meter, for example). High-loft textiles can also be compressed. In other words, they are less dense and fluffy.

Drying rate during the electrospinning process, which may affect fabric characteristics, is difficult to measure directly; however, simulation of drying time can be assessed through a thin film haze test, where the spinning solution is deposited on a glass plate and spread into a thin film of 5 microns or less using a doctor blade in a well-ventilated area. The time from film wiping to film hazing can be reported, along with room temperature and humidity.

Previously, it was thought that highly porous and thick structures were related to softer but weaker fabrics, and stronger fabrics were related to stiff, low porosity thin structures. In an aspect, the present disclosure provides highly porous and thick electrospun materials that have softer and stronger fabric properties. Disclosed herein are electrospun materials that overcome the traditionally accepted tradeoffs above of low residual solvent content and a thicker porous structure, to provide electrospun materials that, in an aspect, exhibit improved mechanical performance, thermal stability, increased softness (compliance) and flexibility. One method for comparing differing electrospun fabric performance is to measure apparent burst and stiffness to normalize mechanical performance against fabric thickness, or more importantly fabric area weight. This can be expressed in terms of (load in Newtons)/(thickness in mm) or (load in Newtons)/(density in g/cm³).

In an aspect, a disclosed polymer composition is an absorbable copolymer synthesized from cyclic monomers of glycolide, lactide, caprolactone, trimethlyene carbonate (TMC) or p-dioxanone. In an aspect, a particular monomer percentage is less than 90%, less than 85%, less than 80%, or less than 75%. In an aspect, a monomer percentage of a monomer is greater than 50%, greater than 55%, greater than 60%, or greater than 65%. For example, a particular monomer percentage can be from 50% to 90% (e.g., from 50% to 70%, from 70% to 90%, from 50% to 60%, from 60% to 70%, from 70% to 80%, from 80% to 90%, from 50% to 85%, from 50% to 80%, from 50% to 75%, from 50% to 65%, from 55% to 90%, from 60% to 90%, from 65% to 90%, from 75% to 90%, from 55% to 85%, from 60% to 80%, or from 65% to 75%). In an aspect, a disclosed copolymer comprises of a block structure of 3 or more block segments. In an aspect, a disclosed copolymer structure comprises a linear structure. In an aspect, a disclosed copolymer comprises is flexible or amorphous and comprises a multi-armed prepolymer comprising 3 or more arms. In an aspect, an electrospun material made with a disclosed copolymer is dimensionally and thermally stable.

Polymeric compositions used in electrospinning fabrics disclosed herein may comprise polymers or copolymers such as polyesters, polyester-carbonates, polyethers, polyether-ester or copolymers of the above. In an aspect, a composition may comprise a bioabsorbable polymer such as a copolymer of glycolic and lactic acid such as poly (glycolic-co-lactic) acid (PGLA) and poly(lactic-co-glycolic) (PLGA), polyglycolic acid (PGA) and copolymers thereof, a polyhydroxyalkanoate (PHA) such as: polyhydroxybutyrate (PHB); poly-4-hydroxybutyrate (P4HB); polyhydroxyvalerate (PHV); polyhydroxyhexanoate (PHH); polyhydroxyoctanoate (PHO) and their copolymers, and polycaprolactone (PCL) or combinations of the above. In an aspect, a composition comprises a bioabsorbable polyester. Disclosed are polymers that are degradable by hydrolysis or other biodegradation mechanisms and contain the following monomeric units of trimethylene carbonate, lactide, glycolide, F-caprolactone, and para-dioxanone.

In an aspect, a polymer is an absorbable copolymer of PGLA. In an aspect, the monomer ratio of glycolide to lactide in the PGLA used for the polymerization may be 95:5, 90:10, 85:15, 80:20, 75:25, 70:30, 65:35, 60:40, 55:45 or ratios between these amounts. In an aspect, the monomer ratio is 90:10. In an aspect, a disclosed electrospinning composition may comprise a bioabsorbable polyether-ester such as polydioxanone (PDO). Also disclosed are co-polymers comprised of polymers where the majority (w/w/) of the polymer is comprised of PDO, poly(epsilon-caprolactone) and its copolymers, poly(L-lactic acid), and others. In an aspect, the amount of PDO may range from 10% to 80%. In an aspect, the amount of PDO is about 33%.

In an aspect, a composition may comprise a nonabsorbable fiber, including but not limited to PET, polyurethanes, polypropylene, PEEK, or different types of nylon. A nonabsorbable fiber may be present in an amount ranging from 10% to 80%.

In an aspect, a disclosed electrospun fabric comprises at least two fiber populations. One fiber population comprises a polymer that loses more than 50% of its strength in less than 7 days. In an aspect, one fiber population loses more than 50% of its strength in more than 7 days, more than 14 days, or more than 30 days.

In an aspect, a disclosed electrospun fabric comprises of one or two fiber populations comprising a polymer with two or more block sections. One fiber population, or at least one block section of a polymer, comprises a polymer that loses more than 50% of its strength in less than 7 days. In an aspect, one fiber population, or at least one block section of a polymer, loses more than 50% of its strength in more than 7 days, more than 14 days, or more than 30 days.

In an aspect, a polymer or polymer block species for providing at least one of porosity, thickness, softness, thermal stability or improved mechanics to a disclosed fabric herein may a bioabsorbable polyether-ester comprising poly(para-dioxanone). In an aspect, such a polymer or polymer block species may comprise at least 30 percent w/w of the thermally stable electrospun material. In an aspect, a polymer or polymer block species may comprise a bioabsorbable polyester, which may be a copolymer synthesized from monomers of glycolide, lactide, caprolactone, or p-dioxanone.

In an aspect, a polymer or polymer block species for providing at least one of porosity, thickness, softness, thermal stability or improved mechanics to a disclosed fabric herein may comprise a bioabsorbable polyester comprising glycolide repeat units. In an aspect, this contributing species may comprise at least 50 percent of the electrospun material. In an aspect, such a polymer or polymer block species may comprise a bioabsorbable polyester, which may be a copolymer synthesized from monomers of glycolide, lactide, caprolactone, trimethylene carbonate (TMC), or p-dioxanone.

In an aspect, a polymer or polymer block species for providing at least one of porosity, thickness, softness, thermal stability or improved mechanics to a disclosed fabric herein may comprise a bioabsorbable polyester comprising poly(caprolactone). In an aspect, such a polymer or polymer block species may comprise at least 10 percent of a disclosed electrospun material. In an aspect, such a polymer or polymer block species may comprise a bioabsorbable polyester, which may be a copolymer synthesized from monomers of glycolide, lactide, caprolactone, trimethylene carbonate (TMC), or p-dioxanone. In an aspect, a polymer or polymer block species for providing at least one of porosity, thickness, softness, thermal stability or improved mechanics to a disclosed fabric herein may comprise a bioabsorbable copolyester comprising poly(caprolactone-glycolide-TMC). In an aspect, this contributing species may comprise at least 10 percent of the electrospun material. In an aspect, such a polymer or polymer block species may comprise a bioabsorbable polyester, which may be a copolymer synthesized from monomers of glycolide, lactide, caprolactone, trimethylene carbonate (TMC), or p-dioxanone.

In an aspect, a polymer comprised in an electrospinning composition that is used to form an electrospun material, such as a fabric, may comprise a polymer that is thermally stable at 25° C., at 37° C., at 50° C., or at or above 100° C.

In an aspect, an electrospinning composition that is used to form an electrospun material, such as a fabric, may have a solution viscosity of about 300-100 cP at the electrospinning temperature. Such a solution viscosity may be achieved by adjusting the polymer(s) concentration of the electrospinning composition. It is currently believed that solution viscosity is dependent on temperature, polymer concentration, molecular weight, solvent affinity, branching, arm structure, block structure, and addition of other chemical moieties which may impact molecular volume.

In an aspect, a multiple fiber population electrospun fabric may include at least two fiber populations wherein at least one fiber population is a thermally stable polyether-ester and at least one fiber population is a thermally unstable bioabsorbable polyester. The at least two fiber populations may be dispersed throughout the three-dimensional structure of the multiple fiber electrospun fabric and may mimic the fibrous topography of the extracellular matrix.

In an aspect, a thermally stable polyether-ester may comprise at least 30 percent w/w of a thermally stable electrospun material. In an aspect, a thermally stable polyether-ester may comprise poly(para-dioxanone). In an aspect, a thermally unstable bioabsorbable polyester may comprises a poly(L-lactide-co-glycolide) copolymer. In an aspect, a thermally stable polyether-ester comprises at least 33 percent of a multiple fiber population electrospun fabric. In an aspect, pore size of a multiple fiber population electrospun fabric may be maintained, within a 10% range, after exposure of the electrospun fabric to temperatures of up to 50° C.

In an aspect, a method of making an electrospun material, such as a fabric, may comprise dissolving a bioabsorbable polyester and a polyether-ester in one or more solvents. The bioabsorbable polyester may be dissolved in a solvent solution that does not comprise the polyether-ester, or both the bioabsorbable polyester and the polyether-ester may be dissolved together in a single solvent solution. The resulting solution(s) may then be dispensed in an intermixed fashion onto a substrate to form an electrospun material, such as a fabric. An electrospun material, such as a fabric, may be formed into a three-dimensional structure wherein the bioabsorbable polyester and polyether-ester are dispersed throughout the three-dimensional structure of the electrospun material, such as a fabric.

In an aspect, a disclosed electrospun material may comprise a bioabsorbable polyester comprising trimethylene and/or caprolactone repeat units.

In an aspect, a disclosed electrospinning composition or an electrospun material made by methods disclosed herein may comprise one or more therapeutic or pharmaceutical or active agents. For example, pores of a disclosed electrospun material may comprise, such as by loading, one or more one or more therapeutic or pharmaceutical or active agents.

The current disclosure provides electrospun materials having characteristics such as a reduction in shrinkage when exposed to temperatures up to 50 degrees C., handling properties, mechanics, and morphology. Thermal stability in an electrospun material may be achieved by utilizing a minor polymer component providing a stabilizing effect in conjunction with a major polymer component in the polymers used for the electrospun material. It is currently believed that the stabilizing effect is due to the minor component, such as “stabilizing” fibers, providing long range stability, such as overall fabric dimensions, as well as short range stability via individual unstable fiber elements that are not necessarily bound by the other stabilizing fibers. Thermally stabile electrospun materials are taught at least by PCT Application Serial Nos. PCT/US2015/013732; PCT/US2015/013723; and related US and international patents and patent applications, each of which is herein incorporated in its entirety.

Electrospun fibers of the current disclosure may range in diameter from 0.1 to 10 m, from 0.25 to 5 μm, from 0.4 to 1.6 μm, of from less than or equal to 1.75 μm. Though not wishing to be bound by any particular theory, it is currently believed in the art that in making an electrospun material, the larger the fiber diameter, the larger the pore size, and the smaller the diameter, the smaller the pore size. In an aspect, a disclosed electrospun material may exhibit larger pore size with smaller fiber diameters.

A method disclosed herein for making an electrospun material may comprise controlling the pore size of the resulting electrospun material. For example, cryogenic electrospinning may produce highly porous fabrics that are more porous than traditional electrospinning which is performed at room temperature using a collecting drum also at room temperature. In an aspect, for cryogenic electrospinning methods, the collector, e.g., a collecting drum, may be chilled below the freezing (melting point) of water. The larger the temperature gradient, the higher likelihood for ice accumulation. The humidity in the environment around the electrospinning apparatus may be greater than 30% in order to have adequate ambient moisture for ice formation in the resulting electrospun material. For example, if a collecting drum is cooled with dry ice to approximately −80° C., then ice crystal formation will occur as electrospun fibers are deposited on the collecting drum during electrospinning. The chilled collecting drum will then have a deposited mat with ice crystals embedded in the fibers. In an aspect, a second layer of fibers may be deposited onto the surface of the first fibrous layer, and then the two-layer fabric can be lyophilized, as known to those of skill in the art, to vaporize the ice crystals. In an aspect, a method for electrospinning may comprise a lyophilization step following the first or subsequent fiber deposition steps in electrospinning. The electrospun fabric may be removed from the collector and placed under vacuum (≤1.5 Torr) [with a cold source] at a temperature lower than the melting temperature of the solvent used. For example, when water is the solvent, temperature for lyophilization needs to be at or less than 0° C. A two-layer construct, may comprise two layers, each layer of which has properties differing from one or more of the other layer's properties. The first layer (initially deposited onto the collector) may have properties of desired mechanical strength and the second layer may comprise a porous infrastructure that allows for cellular ingrowth. In an aspect, these differing properties may be the result of the different porosities of the two layers: small pores of approximately area of 10 μm² in the first layer whereas larger pores of approximate area of 100-2500 μm², or ranging from hundreds to thousands of m², in the outer layer as a result of the lyophilization procedure. In an aspect, each of the layers may be thermally stable using a thermally stable polymer that is co-spun, through separate spinnerets, with a thermally unstable polymer.

The current disclosure comprises a single-step method to provide pore structure control.

In an aspect, electrospun materials disclosed herein exhibit modularity in strength, modulus and porosity. In an aspect, electrospun materials disclosed herein may be formed into various geometries including core-shell arrangements, islands-in-the-sea configuration, pie-like configurations, as well as variations of fiber placement throughout the cross section of structures disclosed herein. In an aspect, electrospun materials disclosed herein may function as a carrier for biologically active agents such as various drugs, while providing a dimensionally and thermally stabilized construct, especially under the required conditions including the biologically-relevant 37° C., as well as 50° C. which is needed for shelf stability, shipping, and sterilization processing.

Indeed, the current disclosure may be used to form layered, core/sheath, blended, and/or composite fibers. Composite fibers may include fibers blended from two separate polymeric systems that are heterogeneously or homogenously blended. One benefit of employing these constructs would be tissue ingrowth due to the presence of degradable laminates adjacent to intermixed population of bulk material. Even further, articulated surfaces may be produced wherein an aligned fiber surface is formed in contrast to a randomly aligned surface. However, randomly aligned fibers, as opposed to aligned fibers, may be used to form an adhesion surface.

In an aspect, a disclosed electrospun material comprises at least two independent fiber populations, which may be in any desired ratio, 50:50, or one major fiber population and one minor population, and the material may be formed from separate spinning solutions. An electrospun material, which may also be termed a web, a mesh or a fabric, is formed in a single process step without requiring further chemical or mechanical processing to impart thermal, dimensional, and mechanical stability, and does not need such as treatment by ultraviolet light or other means, introduction of crosslinking or stabilizing materials, or layering the web to improve structural integrity.

In an aspect, disclosed herein are compositions and methods for making a nonwoven fabric or mesh. Nonwoven fabrics or meshes are based on a fibrous web. The characteristics of the web determine the physical properties of the final product. These characteristics depend largely on the web geometry, which is determined by the mode of web formation. Web geometry includes the predominant fiber direction, whether oriented or random, fiber shape (e.g., straight, hooked or curled), the extent of inter-fiber engagement or entanglement, crimp and z-direction loft as well as orientation. The resulting structure and density of the electrospun fabric, providing characteristics such as mechanics, feel, and applicability directly relates to the intended uses of the material. Web characteristics are also influenced by the fiber diameter, fiber welding, fiber length, fiber surface characteristics such as fiber porosity, pore size, web weight, chemical and mechanical properties of the polymer or polymers comprising the fiber. Various ways of forming the fibrous web include spun melt, spun bond, melt blowing, solution spinning (i.e., wet-spinning), centrifugal melt spinning, liquid shear spinning and electrospinning. In an aspect, the fibrous web is formed by electrospinning. As used herein, electrospinning is provided as an example of other nonwoven processes, and disclosed compositions are applicable to these nonwoven processes.

The current disclosure may use compositions of one or more polymers or copolymers, such a polymer, copolymer, or one or more polymers or copolymers combined to form a composite fiber. For instance, disclosed are methods of commingling fibers that include electrospinning of at least two distinct and independent fiber populations, each comprising a polymer or copolymer, from separate spinnerets, which creates intermingled fibers. Polymer composition and ratios of the resulting fibers in an electrospun material such as a mesh can vary based on the amount of polymer (fiber) deposited and can be controlled by the flow rate of the fibers being dispensed to form the mesh.

The distribution of differing fibers, differing fiber types, in an electrospun material may vary. For example, one or more fiber types may differ as to polymeric composition. The distribution may be uniform throughout the web, such as horizontally or vertically uniform or uniform throughout the thickness, length and width of the web. The distribution may also be random with one fiber type distributed through a web of major fiber population in a random fashion. Further, the distribution may also be such that “patches” or localized regions of one fiber type are located throughout the web such that groups of that fiber type are located in some locations but absent in others forming laminates of that fiber population between the one or more differing fiber types or variations of the fiber types. In an aspect, a disclosed electrospun material exhibits uniform random distribution throughout the thickness or depth of the resultant web. In an aspect, the ratio of a first fiber type to a second fiber type by weight may be 85/15, 80/20, 75/25, 70/30, 65/35, 60/40, 55/45, and 50/50 as well as values falling between the enumerated ratios. In an aspect, a first fiber type to a second fiber type ratio may be 67% to 33%.

Disclosed fibers may comprise polymers such as polyesters, polyester-carbonates, polyethers, polyether-ester or copolymers of the above. In an aspect, a major fiber is a bioabsorbable polymer such as a homopolymer or copolymer of polyglycolide (PGA) and copolymers, thereof, poly (glycolic-co-lactic) acid (PGLA) and poly(lactic-co-glycolic) (PLGA), poly(glycolide-co-TMC), poly(glycolide-co-caprolactone-co-TMC), polyglycolic acid (PGA) and copolymers thereof, a polyhydroxyalkanoate (PHA) such as: polyhydroxybutyrate (PHB); poly-4-hydroxybutyrate (P4HB); polyhydroxyvalerate (PHV); polyhydroxyhexanoate (PHH); polyhydroxyoctanoate (PHO) and their copolymers, and polycaprolactone (PCL) or combinations of the above. In an aspect, a major fiber is a bioabsorbable polyester. Additionally, any polymer that is degradable by hydrolysis or other biodegradation mechanisms and contains the following monomeric units of trimethylene carbonate, lactide, glycolide, F-caprolactone, and para-dioxanone is applicable.

In an aspect, a disclosed copolymer comprises a block structure wherein at least one block is amorphous and at least one block is semicrystalline. For example, an amorphous block may comprise a polyester or polyester carbonate synthesized from ring-opening cyclic monomers. Examples of these cyclic monomers may include, but are not limited to, glycolide, lactide, F-caprolactone, trimethylene carbonate, p-dioxanone, 1,5-dioxepan-2-one, or a morpholine-2,5-dione. A semicrystalline block may comprise a polyester or polyester carbonate synthesized from ring-opening cyclic monomers. Examples of cyclic monomers useful in a semicrystalline block may include, but are not limited to, glycolide, lactide, ε-caprolactone, trimethylene carbonate, p-dioxanone, 1,5-dioxepan-2-one, and a morpholine-2,5-dione. In an aspect, a disclosed copolymer comprises a block structure of 3 or more blocks (also referred to as segments). In an aspect, a copolymer structure comprises a linear structure. In an aspect, a copolymer structure comprises a polyaxial prepolymer with end-grafts on each arm. In an aspect, a copolymer structure comprises a polyaxial prepolymer with three or more arms, each of which has an end graft. End grafts may be synthesized from one or monomers known and/or disclosed herein, and may be homogeneous or comprised of one or more blocks. In an aspect, the polymer is dimensionally and thermally stable after electrospinning.

In an aspect, a disclosed polymer is an absorbable copolymer synthesized from a single major monomer component of the selected monomers: glycolide, lactide, caprolactone, or p-dioxanone. In an aspect, the major monomer component is less than 90% w/w, less than 85% w/w, less than 80% w/w, or less than 75% w/w, with a minor component comprising one or more other monomers. In an aspect, the monomer ratio of the major monomer component is greater than 50% w/w, greater than 55%, greater than 60%, or greater than 65%. In an aspect, a copolymer comprises of a block structure of 3 or more block segments. In an aspect, a copolymer structure comprises a linear structure. In an aspect, a copolymer structure comprises a polyaxial prepolymer with end-grafts on each arm. In an aspect, a copolymer structure comprises a polyaxial prepolymer with three or more arms, each of which has an end graft. End grafts may be synthesized from one or monomers known and/or disclosed herein and may be homogeneous or comprised of one or more blocks. A disclosed polymer is dimensionally and thermally stable after electrospinning. As used herein, polymer and copolymer may be used interchangeably, and those of skill in the art can determine which term is intended if needed to differentiate the terms.

In an aspect, at least one block of an absorbable block copolymer used for electrospinning has a glass transition temperature of less than 25° C., less than 15° C., or less than 0° C. In an aspect, an electrospun fabric created from an absorbable block copolymer is thermally stable and dimensionally stable when exposed to temperatures up to 75° C.

In an aspect, an absorbable block copolymer used in methods for making an electrospun fabric has a semi-crystalline segment that has a glass transition temperature greater than 25° C. In an aspect, the semi-crystalline block undergoes crystallization due to solvent induced crystallization due to shift of the glass transition temperature below 25° C. in the electrospinning process. The shift in glass transition temperature allows for thermal transitions above the glass transition temperature that result in limited additional crystallization and associated shrinkage of certain fiber populations or polymer blocks without additional processing.

In an aspect, an absorbable block copolymer used in methods for making an electrospun fabric has a semi-crystalline segment that has a glass transition temperature greater than the electrospinning temperature. The electrospinning temperature is generally the environmental temperature at which the electrospinning is occurring. Generally, there is no additional heating or cooling of the polymer solution or collector, so the assumption is that the polymer solution, atmosphere, and collector are all at essentially the same temperature, unless otherwise noted. In an aspect, a semi-crystalline block undergoes crystallization due to solvent induced crystallization due to shift of the glass transition temperature below temperature of electrospinning. The shift in glass transition temperature allows for thermal transitions above the glass transition temperature that result in limited additional crystallization and its associated shrinkage, without additional processing.

In an aspect, a method of electrospinning comprises a spinning temperature wherein a semicrystalline polymer has a glass transition temperature above the electrospinning temperature and undergoes solvent-induced crystallization to crystallize during the spinning process. In an aspect, a semi-crystalline polymer with a glass transition temperature above the electrospinning temperature undergoes crystallization during the electrospinning process. In an aspect, a method of electrospinning comprises an atmosphere temperature wherein a semicrystalline polymer has a glass transition temperature above the atmosphere temperature and undergoes solvent-induced crystallization to crystallize during or after the spinning process. This occurs as solvent evaporates from the forming electrospun fiber, thereby increasing the polymer concentration to a level where spontaneous crystallization occurs during fiber solidification.

In an aspect, a semi-crystalline polymer with a glass transition temperature above the electrospinning temperature undergoes crystallization during the electrospinning process. In an aspect, select polymers undergoing rapid solvent-induced crystallization during the formation of electrospun fibers between the nozzle and collector are sufficiently high modulus that they are less conformable when collected on the collector drum. Because they are less conformable, z-compaction is minimized and a loftier fabric is created. This is directly related to solvent evaporation rate, solvent-induced crystallization rate, and transitional fiber stiffness (or modulus) at the point of fiber collection on the collector.

In an aspect, the heat of fusion of a disclosed polymer used in methods for making an electrospun fabric, can be analyzed by differential scanning calorimetry at a rate of 20° C./min with a sample size of 3-15 mg, and under goes less than a 40% increase in heat of fusion, less than a 30% increase in heat of fusion, less than a 20% increase in heat of fusion, less than a 10% increase in heat of fusion, less than 5% increase in heat of fusion less than 2% increase in heat fusion when heated above the glass transition temperature to equilibrium post electrospinning.

In an aspect, a disclosed semicrystalline polymer or copolymer used in methods for making an electrospun fabric has a glass transition temperature less than 30° C. more than the electrospinning temperature, less than 20° C. more than the electrospinning temperature, or less than 15° C. more than the electrospinning temperature.

In an aspect, a disclosed semicrystalline polymer or copolymer used in methods for making an electrospun fabric may crystallize to equilibrium (heat of fusion unchanged by differential scanning calorimetry) at 10° C. above the glass transition temperature in less than 1 hour, less than 30 minutes, less than 10 minutes, less than 5 minutes, or less than 2 minutes. In an aspect, a semicrystalline polymer or copolymer used in methods for making an electrospun fabric may crystallize to equilibrium (heat of fusion unchanged by differential scanning calorimetry) at 20° C. above the glass transition temperature in less than 1 hour, less than 30 minutes, less than 10 minutes, or less than 5 minutes, or less than 2 minutes. In an aspect, a disclosed semicrystalline polymer or copolymer used in methods for making an electrospun fabric may crystallize to equilibrium (heat of fusion unchanged by differential scanning calorimetry) at 30° C. above the glass transition temperature in less than 1 hour, less than 30 minutes, less than 10 minutes, less than 5 minutes, or less than 2 minutes.

One aspect that may affect the dimensional and thermal stability of electrospun materials is how well the electrospun material made from particular polymer(s) retains and releases the spinning solvent. In an aspect, a disclosed polymer composition used in methods for making an electrospun material results in an electrospun fabric having a residual solvent of less than 5000 ppm, less than 2000 ppm or less than 1000 ppm. The electrospun material may be further dried after electrospinning to reach lower levels of less than 2000 ppm, less than 1000 ppm, or less than 100 ppm. Disclosed herein are polymeric nonwoven materials with little to no residual solvent which may include the polymer, the solvent, the electrospinning conditions, as well as the electrospun sheet fiber dimensions/density that define how much residual solvent is left in the fabric.

In an aspect, the polymer molecular weight by inherent viscosity is less than 3 dL/g, less than 2.5 dL/g, less than 2.0 dL/g, less than 1.75 dL/g, or less than 1.5 dL/g. In an aspect, the polymer molecular weight by inherent viscosity is greater than 0.5 dL/g, greater than 0.7 dL/g, or greater than 0.9 dL/g. In an aspect, the polymer molecular weight by inherent viscosity is between 0.5 dL/g to 3 dL/g, from 0.7 to 2.5 dL/g, from 0.7 dL/g to 2.0 dL/g, from 0.7 dL/g to 1.75 dL/g, or from 0.7 dL/g to 1.5 dL/g.

In an aspect, a solvent for electrospinning is a polar solvent. Examples include, but are not limited to, hexafluoro-2-propanol, chloroform, dichloromethane, 1,1,1-trifluoroacetone, dimethylformamide, and dimethylsulfoxide. In an aspect, solvent blends may be used in a method of electrospinning.

In an aspect, a disclosed polymer used in methods for making an electrospun fabric, analyzed by differential scanning calorimetry at a rate of 20° C./min with a sample size of 3-15 mg, has a heat of fusion greater than 20 J/g, greater than 25 J/g, greater than 30 J/g, greater than 35 J/g, or greater than 40 J/g. In an aspect, a disclosed polymer used in methods for making an electrospun fabric used in methods for making an electrospun fabric, analyzed by differential scanning calorimetry at a rate of 20° C./min with a sample size of 3-15 mg, has a heat of fusion less than 100 J/g, less than 90 J/g, less than 80 J/g, less than 75 J/g, less than 50 J/g, or less than 20 J/g. In an aspect, a disclosed polymer used in methods for making an electrospun fabric used in methods for making an electrospun fabric, analyzed by differential scanning calorimetry at a rate of 20° C./min with a sample size of 3-15 mg, has a heat of fusion from 1 J/g to 100 J/g, from 1 J/g to 90 J/g, from 3 J/g to 80 J/g, from 3 J/g to 75 J/g, from 3 J/g to 50 J/g, or from 5 J/g to 20 J/g.

In an aspect, the diameter of a disclosed polymeric fiber used in methods for making an electrospun fabric, analyzed by scanning electron microscopy of fibers within an electrospun sheet have a diameter of less than 10 μm, less than 9 μm or less than 8 μm. In an aspect, the diameter of a disclosed fiber used in methods for making an electrospun fabric, analyzed by scanning electron microscopy of fibers within the electrospun sheet have diameters of greater than 0.2 μm, greater than 0.3 μm, or greater than 0.4 μm. In an aspect, the diameter of a disclosed polymeric fiber used in methods for making an electrospun fabric, analyzed by scanning electron microscopy of fibers within an electrospun sheet have a diameter range from 0.1 μm to 3 μm, from 0.1 μm to 5 μm, from 0.1 μm to 8 μm, from 0.1 μm to 9 μm, and from 0.1 μm to 10 μm.

In order to improve cell infiltration, an electrospun material may comprise at least two fiber populations or fibers comprising two or more polymer blocks, wherein one population or one or more polymer blocks biodegrade to allow for cell infiltration into the electrospun material. In an aspect, an electrospun material comprises two fiber populations made from two different absorbable polymers. The first fiber population may be thermally stable and/or have a mass loss of less than 4 months. In an example, the polymer from the first fiber population comprises a polymer or copolymer with at least 50% of the composition derived from glycolide. The second fiber population may be thermally stable and have a mass loss greater than 4 months. In an example, the second fiber population comprises a polymer or copolymer with at least 50% w/w of the composition derived from glycolide, lactide, or p-dioxanone. The first fiber population may comprise more than 40%, greater than 50%, more than 55%, or more than 60% of the electrospun sheet. The first fiber population may comprise from 40% to 50%, from 45 to 60%, from 55% to 65%, or from 60% to 99% of the electrospun sheet.

In an aspect, the tensile modulus of a disclosed electrospun material, analyzed according to standard methods, comprises of less than 150 MPa, less than 100 MPa, less than 50 MPa, less than 30 MPa, and less than 15 MPa. In an aspect, the tensile modulus, of a disclosed electrospun material, analyzed by standard methods, comprises of greater than 1 MPa, greater than 5 MPa, or greater than 10 MPa. In an aspect, the tensile modulus, of a disclosed electrospun material, analyzed by standard methods, comprises a range from 1 MPa to 50 MPa, from 1 MPa to 30 MPa, from 10 MPa to 30 MPa, or from 15 MPa to 30 MPa.

In an aspect, a disclosed electrospun material, of the present disclosure may further comprise one or more bioactive or therapeutic agents, which are useful in methods of delivering therapeutic agents. A method comprises the step of applying a disclosed electrospun material, at a treatment site wherein the polymers of a disclosed electrospun material comprise at least one polymer type and one or more bioactive and/or therapeutic agents. Biocompatible polymeric compositions containing a therapeutic agent can be prepared by a cold-worked or hot-worked method known to those of skill in the art, depending on the heat-resistance of the therapeutic agent. For therapeutic agents that are likely to be inactivated by heat, a cold-worked method is generally used. Briefly, for the polymer components of a disclosed electrospun material comprising one or more fiber populations, one or more fiber populations may be completely melted in the absence of the therapeutic agent. Each of the melted compositions is cooled to room temperature or below to delay crystallization of the polymer(s) in the composition. In an aspect, cooling is conducted at a rate of about 10° C. per minute. The one or more therapeutic agents is then added to the melted composition at room temperature or below and mixed thoroughly with the polymer composition to create a homogeneous blend.

In an aspect, a disclosed electrospun material may have one or more bioactive and/or therapeutic agents applied to one or more selected sections of the disclosed electrospun material, as opposed to applying the one or more bioactive and/or therapeutic agents to the entire construct. In an aspect, a disclosed electrospun material can be dip-coated or spray-coated with one or more bioactive agents, or with a composition which releases one or more bioactive agents over a desired time frame. In an aspect, the electrospun fibers themselves may be synthesized to release the bioactive agent(s) (see e.g., U.S. Pat. No. 8,128,954 which is incorporated by reference in its entirety).

Bioactive and/or therapeutic agents may include fibrosis-inducing agents, antifungal agents, antibacterial agents, anti-inflammatory agents, anti-adhesion agents, osteogenesis and calcification promoting agents, antibacterial agents and antibiotics, immunosuppressive agents, immunostimulatory agents, antiseptics, anesthetics, antioxidants, cell/tissue growth promoting factors, lipopolysaccharide complexing agents, peroxides, anti-scarring agents, anti-neoplastic, anticancer agents and agents that support ECM integration.

Examples of fibrosis-inducing agents include, but are not limited to talcum powder, metallic beryllium and oxides thereof, copper, silk, silica, crystalline silicates, talc, quartz dust, and ethanol; a component of extracellular matrix selected from fibronectin, collagen, fibrin, or fibrinogen; a polymer selected from the group consisting of polylysine, poly(ethylene-co-vinylacetate), chitosan, N-carboxybutylchitosan, and RGD proteins or peptide sequences greater than one amino acid in length; vinyl chloride or a polymer of vinyl chloride; an adhesive selected from the group consisting of cyanoacrylates and crosslinked poly(ethylene glycol)-methylated collagen; an inflammatory cytokine (e.g., TGF.beta., PDGF, VEGF, bFGF, TNF.alpha., NGF, GM-CSF, IGF-a, IL-1, IL-1-.beta., IL-8, IL-6, and growth hormone); connective tissue growth factor (CTGF); a bone morphogenic protein (BMP) (e.g., BMP-2, BMP-3, BMP-4, BMP-5, BMP-6, or BMP-7); leptin, and bleomycin or an analogue or derivative thereof. Optionally, the device may additionally comprise a proliferative agent that stimulates cellular proliferation. Examples of proliferative agents include: dexamethasone, isotretinoin (13-cis retinoic acid), 17-e-estradiol, estradiol, 1-a-25 dihydroxyvitamin D3, diethylstibesterol, cyclosporine A, L-NAME, all-trans retinoic acid (ATRA), and analogues and derivatives thereof (see US Pat. Pub. No. 2006/0240063, which is incorporated by reference in its entirety).

Examples of antifungal agents include, but are not limited to polyene antifungals, azole antifungal drugs, and Echinocandins.

Examples of antibacterial agents and antibiotics include, but are not limited to triclosan, erythromycin, penicillins, cephalosporins, rifampin, minocycline, doxycycline, gentamicin, vancomycin, tobramycin, clindamycin, and mitomycin.

Examples of anti-inflammatory agents include, but are not limited to non-steroidal anti-inflammatory drugs such as ketorolac, naproxen, diclofenac sodium and flurbiprofen.

Examples of anti-adhesion agents include, but are not limited to talcum powder, metallic beryllium and oxides thereof, copper, silk, silica, crystalline silicates, talc, quartz dust, and ethanol.

Examples of osteogenesis or calcification promoting agents include, but are not limited to bone fillers such as hydroxyapatite, tricalcium phosphate, calcium chloride, calcium carbonate, and calcium sulfate, bioactive glasses, bone morphogenic proteins (BMPs), such as BMP-2, BMP-3, BMP-4, BMP-5, BMP-6, and BMP-7.

Examples of immunosuppressive agents include, but are not limited to glucocorticoids, alkylating agents, antimetabolites, and drugs acting on immunophilins such as ciclosporin and tacrolimus.

Examples of immunostimulatory agents include, but are not limited to interleukins, interferon, cytokines, toll-like receptor (TLR) agonists, cytokine receptor agonist, CD40 agonist, Fc receptor agonist, CpG-containing immunostimulatory nucleic acid, complement receptor agonist, or an adjuvant.

Examples of antiseptics include, but are not limited to chlorhexidine and tibezonium iodide.

Examples of antioxidants include, but are not limited to antioxidant vitamins, carotenoids, and flavonoids.

Examples of anesthetic include, but are not limited to lidocaine, mepivacaine, pyrrocaine, bupivacaine, prilocalne, and etidocaine.

Examples of cell growth promoting factors include but are not limited to, epidermal growth factors, human platelet derived tgf-b, endothelial cell growth factors, thymocyte-activating factors, platelet derived growth factors, fibroblast growth factor, fibronectin or laminin.

Examples of lipopolysaccharide complexing agents include but are not limited to polymyxin.

Examples of peroxides, include, but are not limited to benzoyl peroxide and hydrogen peroxide.

Examples of antineoplastic/anti-cancer agents include, but are not limited to paclitaxel, carboplatin, miconazole, leflunamide, and ciprofloxacin.

Examples of anti-scarring agents include, but are not limited to cell-cycle inhibitors such as a taxane, immunomodulatory agents such as serolimus or biolimus (see, e.g., paras. 64 to 363, as well as all of us U.S. Pat. Pub. No. 2005/0149158, which is incorporated herein by reference in its entirety).

Examples of agents that support ECM integration include, but are not limited to gentamicin.

It is recognized that in certain forms of therapy, combinations of agents/drugs in the same disclosed electrospun material can be useful in order to obtain an optimal effect. Thus, for example, an antibacterial and an anti-inflammatory agent may be combined in a disclosed electrospun material to provide combined effectiveness.

In an aspect, synthetic absorbable polymers may be formed into medical implants and/or scaffolds for tissue engineering and drug delivery devices. For instance, electrospinning may be employed to produce micro-fibrous materials with a topography similar to the native extracellular matrix. In an aspect, fiber formation through electrospinning may occur on the order of milliseconds. This may inhibit or delay polymer crystallization and may yield a dense material with small pores and little fabric loft or softness that is unsuitable for the intended application. Some example applications may include but are not limited to tissue engineering scaffold, burn wound dressing, wound healing membrane, hernia mesh, separation barrier, device covering membrane or envelope, local drug delivery, reinforcing scaffold, sling, void filler, wrap, tissue bulking, and occlusion. These applications may take the form of the following examples of flat sheet, pouch, 3D contoured sheet, tubular structure, thin strips, tape, and coating, but are not limited to just these examples.

In an aspect, a method of making an implant or scaffold is disclosed. PGLA and poly(para-dioxanone) (PPD), was procured from Purac and Evonic, respectively, was prepared by separately dissolving each of the PGLA and PPD in Hexafluoroisopropanol (HFIP), obtained from Dupont, and electrospinning the resulting solutions on an electrospinning apparatus using a field of 1.74 kV/cm. Polymer solutions were prepared by weighing out 0.8 g PGLA and 0.9 g PPD, dissolving both in 10 mL of HFIP overnight with moderate shaking (75 rpm) at 50° C. After overnight incubation (≥12 hrs) solutions were allowed to cool to room temperature, e.g., 22±3° C. for 1 hour prior to loading into syringes. Solutions were loaded into 12 ml syringes dispensed out of adjacent, yet separate, 20 gauge needles arranged with a needle spacing of about 0.5 inches. In order to generate varying fabric compositions, the flow rate and the number of needles per solution type (PPD vs PGLA) were modulated to generate fabrics with varying compositions and properties.

In another example, PGLA and PPD solutions were deposited from an array of separate 20 gauge needles at varying flow rates between 1 and 12 mL/hour. Composite materials were generated with the following PGLA:PPD ratios 2:0, 2:1, 1:1, 1:2, and 0:2. These ratios can be generated by multiple methods, or a combination of methods, which include varying: (1) the relative number of needles, (2) individual needle flow rates, and (3) solution concentrations. In this particular example, solution concentrations remained constant and the number of needles was varied to generate the various compositions. The resulting fabric contained well-defined and relatively uniform small-diameter fibers deposited in a randomly oriented fibrous mat. Differences between PGLA and PPD fibers were not obvious based on SEM and light microscopy, but the presence of fibers without significant size and deformation indicate that fibers formed from the individual solutions and contain only one material, as opposed to very large fibers or inconsistent/film-like morphology which could be associated with solution blending. These electrospun samples were assessed for morphology, tensile mechanics, free shrinkage, and crystallization.

In an aspect, PGLA was dissolved in HFIP at 4.8% and PPD was dissolved in HFIP at 5.3%. Electrospinning was conducted by dispensing the different solutions through an alternating needle sequence within the needle array (separated by 0.57″ each) to generate an intermingled population of PGLA and PPD fibers. The flowrate of PGLA solution was 5 mL/hr/needle and the flowrate of PPD solution was 2.5 mL/hr/needle. The electrospun fabric was created with equal needles of PGLA and PET solutions, creating a fabric that, by weight, contained 33% PPD and 67% PGLA, as well as by varying the relative number of each needle type to change the final composition.

Mechanical analysis indicated that incorporation of PPD decreased the ultimate tensile load and elongation at high content levels, such as >50% while suture pull-out was lowered at all loading levels with PPD>33%. In an aspect, PPD of 33% exhibits the optimal mechanical properties while minimizing thermal shrinkage. DSC analysis indicated that thermally treated samples had a reduction in crystallization peak.

In one aspect, the softness of the material can be characterized by the deflection angle or tensile modulus. The amount of residual solvent in the material has an impact on the material softness as it acts like a plasticizer for the material. However, all bioresorbable electrospun materials should target a low amount of residual solvent to be biocompatible. Semi-crystalline polymers with high glycolide (>85%) or high lactide (>85%) are very challenging to remove residual solvents such at HFIP, and mechanics can be misleading due to the amount of residual solvent. For example, MX2 in example 6 has a deflection angle from a 50 mm sample of 69°, but should be 0° with lower residual solvent values around 10,000 ppm. In this embodiment, the soft materials should have a tensile modulus of <40 MPa, of <30 MPa, and <25 MPa, and <22 MPa. The residual solvent for these samples may be <5000 ppm, <2000 ppm, <1000 ppm, or <500 ppm.

In an aspect, a disclosed electrospun material is wettable in water, saline solution, or phosphate buffer saline at room temperature in less than 2 minutes, less than 1 minute, less than 30 sec, less than 10 sec and less than 5 sec.

In an aspect, the electrospun material is a block copolymer of an amorphous segment (A), a semicrystalline endgraft (B), and an initiator (I) wherein the structure may be I-A-B and the initiator may be monofunctional, difunctional, trifunctional, and other multifunctional moieties. In an aspect, an electrospun material is bioresorbable. By bioresorbable it is meant that the material will degrade in the human body under normal physiological conditions.

In an aspect, an electrospun material is lofty. One measure of lofty is the density of the material. In an aspect, an electrospun material has a density of less than 375 kg/m³, a density of less than 350 kg/m³, and a density of less than 340 kg/cm³. In an aspect, an electrospun material has a density of greater than 150 kg/m³, a density of greater than 200 kg/m³, and a density of greater than 225 kg/cm³.

In an aspect, an electrospun material comprises a semicrystalline polyether. An example of a polyether is polyethylene glycol, polypropylene glycol, or copolymers thereof. Copolymers may be block or random in structure. The molecular weight of the copolymer may be greater than 700 Da, greater than 1000 Da, and greater than 2000 Da.

In an aspect, an electrospun material has a deflection angle of greater than 10, greater than 5°, greater than 10°, greater than 20°, or greater than 300 for a 50 mm sample that is tested by a modified version of ASTMD1388.

In an aspect, the material (e.g., the polyester or polyester carbonate) is a triblock polymer structure with an amorphous segment comprises a glass transition temperature of less than 0° C., less than −20° C., or less than −40° C.

In an aspect, a disclosed electrospun material may have a three-dimensional structure. In an aspect, the fiber populations may be dispersed throughout the three-dimensional structure such that the relative ratios of the fibers to one another remains substantially constant throughout the structure of the fabric. In an aspect, the structure of the fabric may be modified such that the ratios of the fibers to one another vary throughout the structure, such as one fiber being predominately present on the exteriors of the three-dimensional structure but less present, or lacking altogether, in the interior of the structure.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

The examples below are intended to further illustrate certain aspects of the methods and compositions described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for.

Compliant Electrospun Construct from Absorbable Polymers:

### Example 1

Polymers for electrospinning were selected from groups consisting of linear homopolymers, linear random copolymers, linear block copolymers, and triaxial block copolymers. Linear homopolymers were prepared with a single monomer type polymerized from a monofunctional or difunctional initiator, e.g. 1,3-propanediol, with stannous octoate catalyst via ring opening polymerization (ROP) to produce high molecular weight polymers as a single, unbranched chain. Similarly, linear random copolymers were produced using an initiator and catalyst via ROP, but with more than one monomeric repeat unit wherein the repeat units are distributed randomly throughout the polymer chain.

Linear block copolymers were made through a 2-step polymerization process, wherein the first polymerization step created a pre-polymer of specific monomer ratios as listed in the tables using a difunctional initiator and stannous octoate catalyst via ROP. This pre-polymer has a lower molecular weight. In a second polymerization step, the pre-polymer was reacted with additional monomer(s) and catalyst to further increase molecular weight by adding a second block, also referred to as an end graft, having a different composition from the first block, as indicated in the tables below.

Triaxial block copolymers were prepared from a trifunctional initiator via a 2-step polymerization process, wherein the first polymerization step created a pre-polymer of specific monomer ratios as listed in the tables using a trifunctional initiator (trimethylolpropane) with stannous octoate catalyst via ROP. This 3-arm prepolymer was further reacted in a second step with additional monomer(s) and catalyst to further increase molecular weight by adding a second block having a different composition than the first.

All polymeric materials were ground to a narrow particulate distribution by sieving through classification screens of 1 mm to remove fine particulate and 4 mm to remove large particulate. Sieved materials were purified via a vacuum extraction process and dried to low moisture content.

TABLE 1

| | | | | | Melting |
|---|---|---|---|---|---|
| | | | | | Temper- |
| | | | | Glass | ature, |
| | | | | Transition | ° C./ |
| | | | | Temper- | Heat of |
| | | Composition | IV | ature, | Fusion, |
| Polymer | Structure | (mol %) | (dL/g) | ° C. | J/g |
| MG 5 | Triaxial | 74/24/2 | 1.5 | 5 to 10 | 140 to 160/ |
| | block | Poly(glycolide- | | | 20 to 40 |
| | copolymer | co-capro- | | | |
| | | lactone-co- | | | |
| | | trimethylene | | | |
| | | carbonate) | | | |
| RD 7 | Triaxial | 55/25/20 | 2.0 | 25° C. | 210 to 225/ |
| | block | Poly(glycolide- | | | 15 to 50 |
| | copolymer | co-trimethylene | | | |
| | | carbonate-co- | | | |
| | | capro- | | | |
| | | lactone) | | | |
| MG 9 | Triaxial | 93/5/2 | 1.7 | 40 to 50 | 210 to 230/ |
| | block | Poly(glycolide- | | | 50 to 85 |
| | copolymer | co-capro- | | | |
| | | lactone-co- | | | |
| | | trimethylene | | | |
| | | carbonate) | | | |
| PPD 3 | Linear | 100% | 1.8 | −10 to 0 | 80 to 120/ |
| | homo- | Poly(diox- | | | 65 to 95 |
| | polymer | anone) | | | |
| MX 2 | Linear | 95/5 | 1.9 | 40 to 50 | 200 to 225/ |
| | random | Poly(glycolide- | | | 50 to 85 |
| | copolymer | co-lactide) | | | |
| MX 1 | Linear | 90/10 | 1.8 | 40 to 50 | 195 to 220/ |
| | random | Poly(glycolide- | | | 50 to 85 |
| | copolymer | co-lactide) | | | |
| MDP 3 | Linear | 74/15/11 | 2.4 | 44° C. | 160 to 180/ |
| | block | Poly(l-lactide- | | | |
| | copolymer | co-trimethylene | | | |
| | | carbonate- | | | |
| | | co-capro- | | | |
| | | lactone) | | | |
| PCL | Linear | 100% | 2.0 | −65 | 55 to 70/ |
| | homo- | Poly(capro- | | to −55 | 70 to 100 |
| | polymer | lactone) | | | |
| PLA | Linear | 100% | 2.8 | 50 to 60 | 150 to 190/ |
| | homo- | Poly(l-lactide) | | | 40 to 80 |
| | polymer | | | | |
| ML 6 | Triaxial | 84/14/2 | 1.0 | 35 to 45 | 130 to 150/ |
| | block | Poly(L-lactide- | | | 15 to 25 |
| | copolymer | co-capro- | | | |
| | | lactone-co- | | | |
| | | trimethylene | | | |
| | | carbonate) | | | |
| ML 7 | Triaxial | 64/34/2 | 1.0 | 10 to 20 | 95 to 115/ |
| | block | Poly(L-lactide- | | | 5 to 20 |
| | copolymer | co-capro- | | | |
| | | lactone-co- | | | |
| | | trimethylene | | | |
| | | carbonate) | | | |
| ML 8 | Triaxial | 74/24/2 | 1.0 | 15 to 25 | 95 to 115/ |
| | block | Poly(L-lactide- | | | 5 to 20 |
| | copolymer | co-capro- | | | |
| | | lactone-co- | | | |
| | | trimethylene | | | |
| | | carbonate) | | | |

### Example 2

Making a single component electrospun fabric from a poly-axial co polymer MG-5, using custom multi spinneret electrospinning enclosure and a rotating collector. The polymer solution was made with HexafluoroIsopropanol (HFIP) as the solvent and had a solution viscosity of 550-600 cP at 25° C. and shear rate of 400 s⁻¹. To achieve this viscosity, a target concentration of 16% polymer to solution was mixed in a 50° C. heated vessel at 50 rpm for 42 hours and tested using a viscometer.

The polymer compositions were transferred to eight (8), 60 ml syringes and filled to a volume of 54 ml so that 52 ml of solution was dispensed per syringe. Using two (2), 4-channel high pressure syringe pumps the solution was then dispensed at a flow rate of 0.2 ml/min while a charge of 35 kV was applied. The electrospun material was then collected on a rotating mandrel which 236 mm away from the eight (8), 20 ga needles.

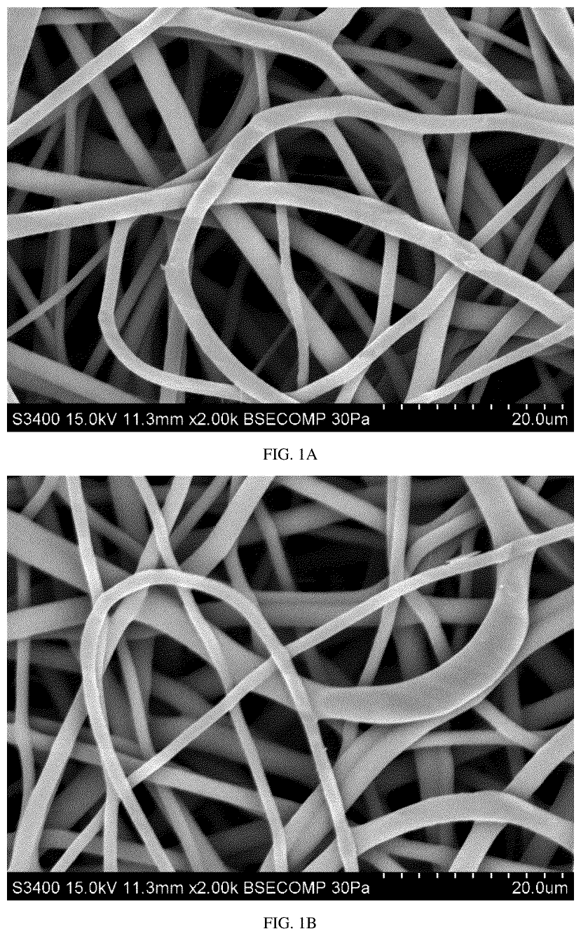

The collected electrospun material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. See FIGS. 1A and 1B.

TABLE 2
MG 5 Material Properties

| Test | Units | Result |
|---|---|---|
| Suture Pull Out | N | 14-19 |
| Tensile Strength | N | 60-75 |
| Modulus | MPa | 18-20 |
| Burst Strength | N | 108-116 |
| Basis Weight | g/m² | 215-220 |
| Thickness | mm | 0.75-0.84 |
| rHFIP | PPM | 0-400 |
| Fiber size | μm | 0.3-5 |

### Example 3

Multi-component electrospun fabric from a first polymer, poly-axial polymer (MG5, and a second polymer, PPD-3 (polydioxanone) polymer, using custom multi spinneret electrospinning enclosure and a rotating collector. The polymer solutions were made with HexafluoroIsopropanol (HFIP) as the solvent and targeted a solution viscosity of 350-600 cP at 25° C. and shear rate of 400 s⁻¹. To achieve this viscosity, a target concentration of 7-16% polymer to solution was mixed with, or without, a 50° C. heated vessel at 50 rpm for 42 hours and tested using a viscometer.

Material was transferred to eight (8), 60 ml syringes and filled to a volume of 54 ml so that 52 ml of solution could be dispensed per syringe. Using two (2), 4-channel high pressure syringe pumps the solution was then dispensed at a flow rate of 0.2 ml/min while a charge of 35 kV was applied. The material was then collected on a rotating mandrel which 236 mm away from the eight (8), 20 ga needles.

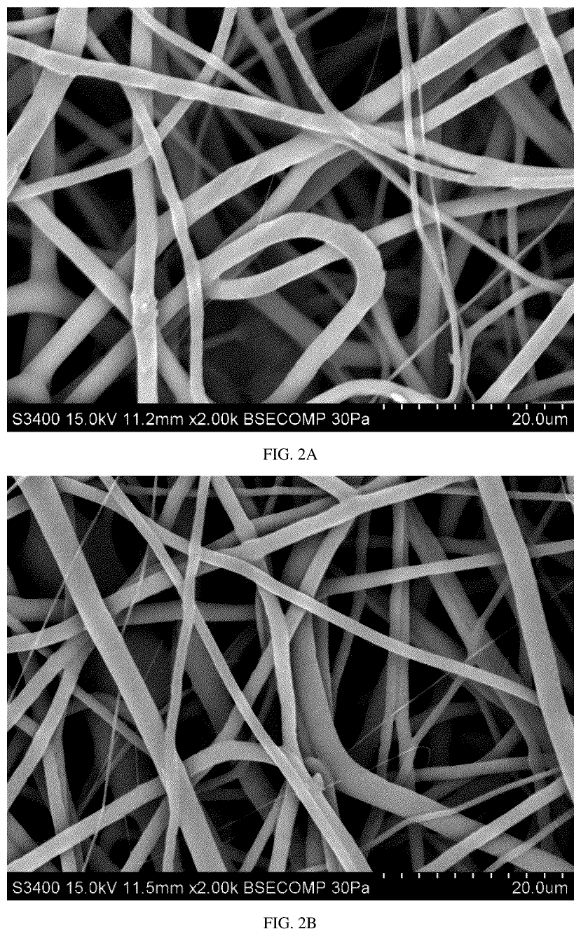

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. See FIGS. 2A and 2B.

TABLE 3
MG 5/PPD 3 (32/9 ratio) Material Properties

| Test | Units | Result |
|---|---|---|
| Suture Pull Out | N | 11-14 |
| Tensile Strength | N | 60-63 |
| Modulus | MPa | 19-21 |
| Burst Strength | N | 87-91 |
| Basis Weight | g/cm² | 172-173 |
| Thickness | mm | 0.67-0.69 |
| rHFIP | PPM | 0-300 (1000) |
| Fiber size | μm | 0.1-4 |

### Example 4

Multi-component fabric from a first polymer, proprietary poly-axial copolymer MG5, and a second copolymer, RD7, using custom multi spinneret electrospinning enclosure and a rotating collector. The polymer solutions were made with HexafluoroIsopropanol (HFIP) as the solvent and targeted a solution viscosity of 200-600 cP at 25° C. and shear rate of 400 s⁻¹. To achieve this viscosity, a target concentration of 10-16% polymer to solution was mixed in a 50° C. heated vessel at 50 rpm for 42 hours and tested using a viscometer.

Material was transferred to eight (8), 60 ml syringes and filled to a volume of 54 ml so that 52 ml of solution could be dispensed per syringe. Using two (2), 4-channel high pressure syringe pumps the solution was then dispensed at a flow rate of 0.2 ml/min while a charge of 35 kV was applied. The material was then collected on a rotating mandrel which 236 mm away from the eight (8), 20 ga needles.

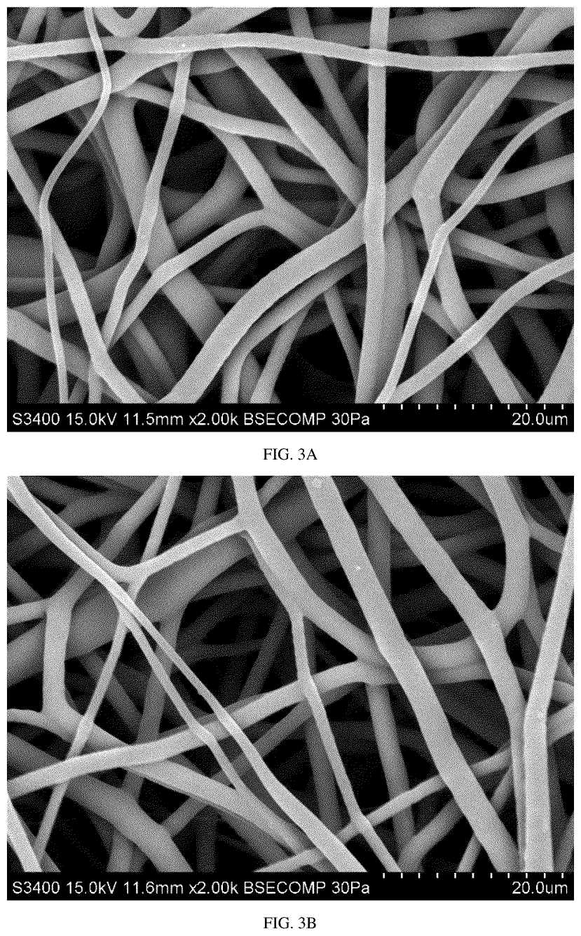

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. See FIGS. 3A and 3B.

TABLE 4
MG 5/RD 7 (8/3 ratio) Material Properties

| Test | Units | Result |
|---|---|---|
| Suture Pull Out | N | 13-17 |
| Tensile Strength | N | 60-65 |
| Modulus | MPa | 20-22 |
| Burst Strength | N | 83-100 |
| Basis Weight | g/m² | 177-188 |
| Thickness | mm | 0.62-0.69 |
| rHFIP | PPM | 0-50 |
| Fiber size | μm | 0.6-6 |

### Example 5

Single component fabric from proprietary poly-axial copolymer, MG9, using custom multi spinneret electrospinning enclosure and utilizes a rotating collector. The polymer solution was made with HexafluoroIsopropanol (HFIP) as the solvent and targeted a solution viscosity of 350-500 cP at 25° C. and shear rate of 400 s⁻¹. To achieve this viscosity, a target concentration of 7-15% polymer to solution was mixed in a 50° C. heated vessel at 50 rpm for 42 hours and tested using a viscometer.

Material was transferred to eight (8), 60 ml syringes and filled to a volume of 54 ml so that 48-52 ml of solution could be dispensed per syringe. Using two (2), 4-channel high pressure syringe pumps the solution was then dispensed at a flow rate of 0.05-0.25 ml/min while a charge of 35 kV was applied. The material was then collected on a rotating mandrel which 236 mm away from the eight (8), 20 ga needles.

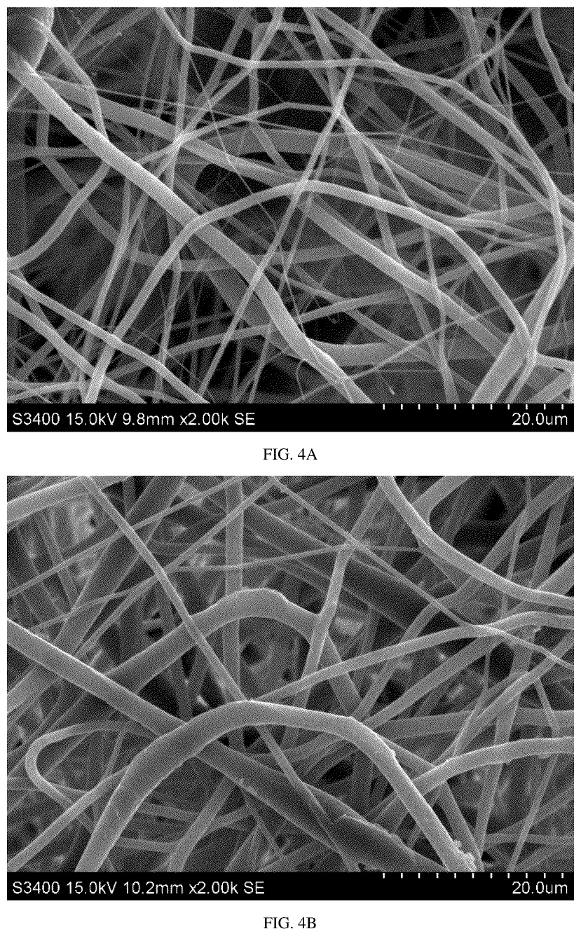

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. See FIGS. 4A and 4B.

TABLE 5
MG 9 Material Properties

| Test | Units | Result |
|---|---|---|
| Suture Pull Out | N | 2-7 |
| Tensile Strength | N | 20-55 |
| Modulus | MPa | Not Tested |
| Burst Strength | N | 40-60 |
| Basis Weight | g/m² | 60-170 |
| Thickness | mm | 0.2-0.95 |
| rHFIP | PPM | 50,000-80,000 |
| Fiber size | μ | 0.1-8 |

### Example 6

Single component fabric from proprietary polymer, MX2, using custom multi spinneret electrospinning enclosure and utilizes a rotating collector. The polymer solution was made with HexafluoroIsopropanol (HFIP) as the solvent and targeted a solution viscosity of 300-400 cP at 25° C. and shear rate of 400 s⁻¹. To achieve this viscosity, a target concentration of 8-11% polymer to solution was mixed in a 50° C. heated vessel at 50 rpm for 42 hours and tested using a viscometer.

Material was transferred to eight (8), 60 ml syringes and filled to a volume of 54 ml so that 52 ml of solution could be dispensed per syringe. Using two (2), 4-channel high pressure syringe pumps the solution was then dispensed at a flow rate of 0.2 ml/min while a charge of 30 kV was applied. The material was then collected on a rotating mandrel which 260 mm away from the eight (8), 20 ga needles.

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. No figures shown.

TABLE 6
MX 2 Material Properties

| Test | Units | Result |
|---|---|---|
| Suture Pull Out | N | 10 |
| Tensile Strength | N | 44.9 |
| Modulus | MPa | Not Tested |
| Burst Strength | N | Not Tested |
| Basis Weight | g/m² | 162 |
| Thickness | mm | 0.481 |
| rHFIP | PPM | 83,565 |
| Fiber size | μm | Not Tested |

### Example 7

Multi-component fabric from a first polymer, poly-axial copolymer MX2, and a second copolymer, RD7, using custom multi spinneret electrospinning enclosure and utilizes a rotating collector. The polymer solutions were made with HexafluoroIsopropanol (HFIP) as the solvent and targeted a solution viscosity of 220-400 cP at 25° C. and shear rate of 400 s⁻¹. To achieve this viscosity, a target concentration of 10-11% polymer to solution was mixed in a 50° C. heated vessel at 50 rpm for 42 hours and tested using a viscometer.

Material was transferred to eight (8), 60 ml syringes and filled to a volume of 54 ml so that 52 ml of solution could be dispensed per syringe. Using two (2), 4-channel high pressure syringe pumps the solution was then dispensed at a flow rate of 0.15 ml/min while a charge of 30 kV was applied. The material was then collected on a rotating mandrel which 260 mm away from the eight (8), 20 ga needles.

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. The material was then again dried using 120° C. heated oven for 20 minutes and tested for suture pull out (SPO), tensile strength, burst strength, basis weight, thickness, residual HFIP using gas chromatography (GC), fiber size using scanning electron microscope (SEM) and softness. No figures shown.

TABLE 7
MX 2/RD 7 Material Properties (21-20 ratio)

| Test | Units | Result (predry) |
|---|---|---|
| Suture Pull Out | N | 8 (11) |
| Tensile Strength | N | 70 (55) |
| Modulus | MPa | Not Tested |
| Burst Strength | N | 110 (55) |
| Basis Weight | g/cm² | 150 (145) |
| Thickness | mm | 0.39 (0.37) |
| rHFIP | PPM | 0 (37,394) |
| Fiber size | μm | Not Tested |

### Example 8

Multi-component fabric from a first polymer, poly-axial copolymer MX1, and a second polymer, PPD-3, using custom multi spinneret electrospinning enclosure and a rotating collector. The polymer solutions were made with HexafluoroIsopropanol (HFIP) as the solvent and targeted a solution viscosity of 330-480 cP at 25° C. and shear rate of 400 s⁻¹. To achieve this viscosity, a target concentration of 7-11% polymer to solution was mixed with, or without, a 50° C. heated vessel at 50 rpm for 42 hours and tested using a viscometer.

Material was transferred to eight (8), 30-60 ml syringes and filled to a volume of 22-36 ml so that 7-35 mL could be dispensed per syringe. Using two (2), 4-channel high pressure syringe pumps the solution was then dispensed at a flow rate of 0.08-0.22 ml/min while a charge of 30 kV was applied. The material was then collected on a rotating mandrel which 236 mm away from the eight (8), 20-25 gauge needles.

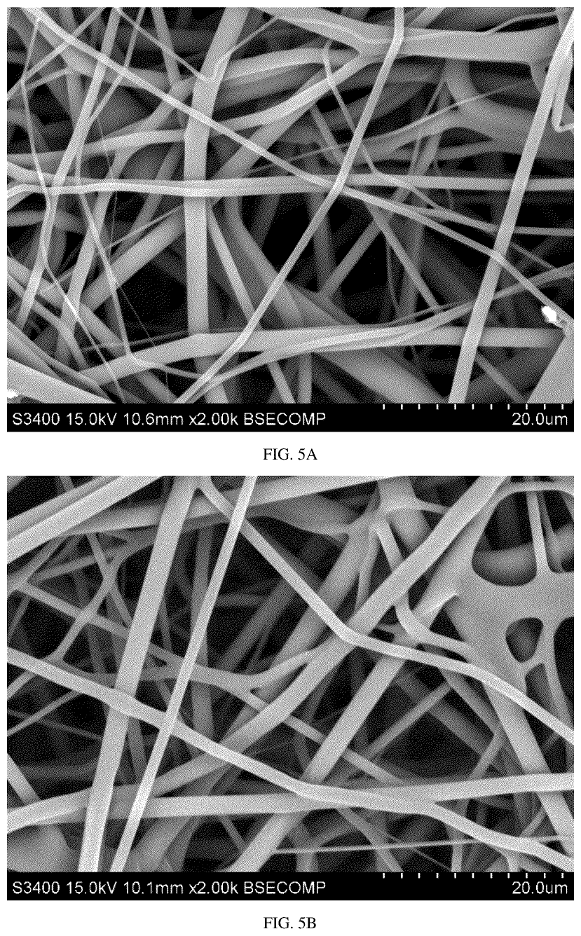

The collected material was then dried using 38-45° C. heated-vacuum three to five (3-5) nights and tested for suture pull out (SPO), tensile strength, burst strength, basis weight, thickness, residual HFIP using gas chromatography (GC), fiber size using scanning electron microscope (SEM) and softness. See FIGS. 5A and 5B.

TABLE 8
MX 1/PPD 3, (2/1 ratio) Material Properties

| Test | Units | Result |
|---|---|---|
| Suture Pull Out | N | 1-12 |
| Tensile Strength | N | 13-70 |
| Modulus | MPa | 40-60 |
| Burst Strength | N | 20-50 |
| Basis Weight | g/cm² | 34-139 |
| Thickness | mm | 0.1-0.9 |
| rHFIP | PPM | 5,000-40,000 |
| Fiber size | μm | 0.2-4 |

### Example 9

Single component fabric from proprietary homopolymer, PPD-3, using custom multi spinneret electrospinning enclosure and utilizes a rotating collector. The polymer solution was made with HexafluoroIsopropanol (HFIP) as the solvent and targeted a solution viscosity of 350-500 cP at 25° C. and shear rate of 400 s⁻¹. To achieve this viscosity, a target concentration of 7-11% polymer to solution was mixed in at 50 rpm for 42 hours and tested using a viscometer.

Material was transferred to eight (8), 60 ml syringes and filled to a volume of 54 ml so that 35-50 ml of solution could be dispensed per syringe. Using two (2), 4-channel high pressure syringe pumps the solution was then dispensed at a flow rate of 0.04-0.2 ml/min while a charge of 35 kV was applied. The material was then collected on a rotating mandrel 200-260 mm away from the eight (8), 20 ga needles.

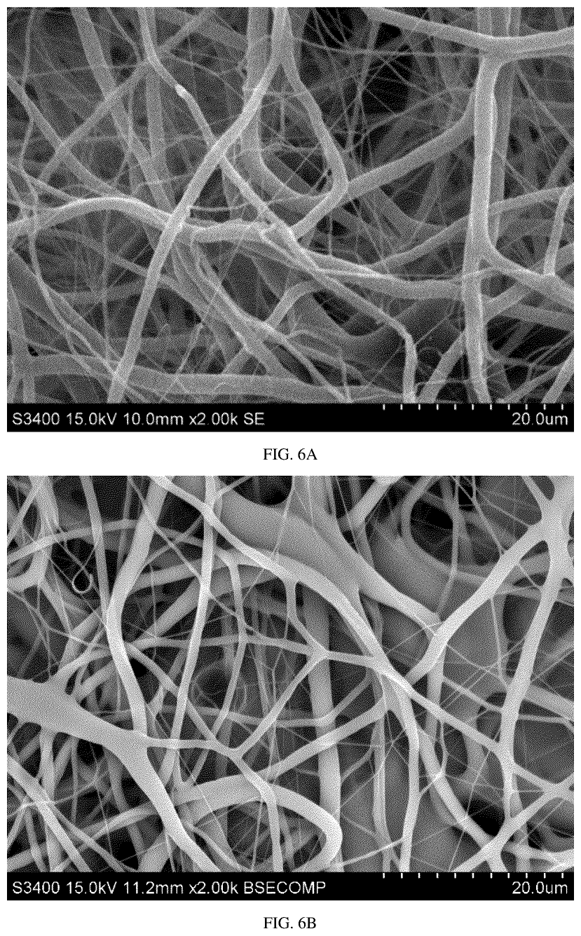

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. See FIGS. 6A and 6B.

TABLE 9
PPD 3 Material Properties

| Test | Units | Result |
|---|---|---|
| Suture Pull Out | N | 2-13 |
| Tensile Strength | N | 11-80 |
| Modulus | MPa | 15-50 |
| Burst Strength | N | 35-50 |
| Basis Weight | g/m² | 50-150 |
| Thickness | mm | 0.1-0.6 |
| rHFIP | PPM | 0-6000 |
| Fiber size | μm | 0.1-9 |

### Example 10

Multi-component fabric from a first polymer, poly-axial copolymer MX2, and a second polymer, PPD-3, using custom multi spinneret electrospinning enclosure and utilizes a rotating collector. The polymer solutions were made with HexafluoroIsopropanol (HFIP) as the solvent and targeted a solution viscosity of 330-480 cP at 25° C. and shear rate of 400 s⁻¹. To achieve this viscosity, a target concentration of 7-11% polymer to solution was mixed with, or without, a 50° C. heated vessel at 50 rpm for 42 hours and tested using a viscometer.

Material was transferred to eight (8), 30-60 ml syringes and filled to a volume of 22-36 ml so that 7-16 mL could be dispensed per syringe. Using two (2), 4-channel high pressure syringe pumps the solution was then dispensed at a flow rate of 0.08-0.22 ml/min while a charge of 30 kV was applied. The material was then collected on a rotating mandrel which 236 mm away from the eight (8), 20-25 gauge needles.

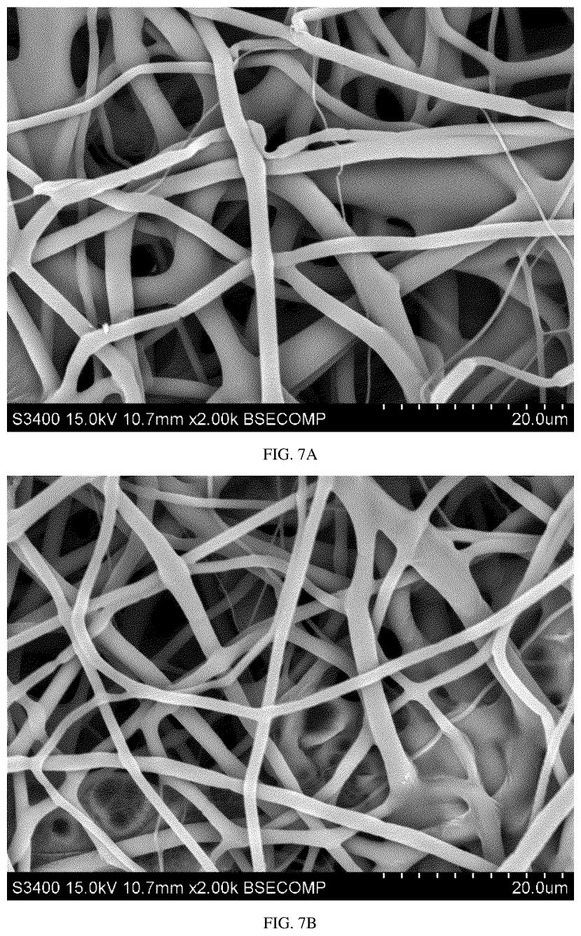

The collected material was then dried using 38° C. heated-vacuum three to five (3-5) nights and tested for suture pull out (SPO), tensile strength, burst strength, basis weight, thickness, residual HFIP using gas chromatography (GC), fiber size using scanning electron microscope (SEM) and softness. See FIGS. 7A and 7B.

TABLE 10
MX 2/PPD 3 (2/1 ratio) Material Properties

| Test | Units | Result |
|---|---|---|
| Suture Pull Out | N | 1-3 |
| Tensile Strength | N | 12-22 |
| Modulus | MPa | Not Tested |
| Burst Strength | N | Not Tested |
| Basis Weight | g/cm² | 30-40 |
| Thickness | mm | 0.07-0.15 |
| rHFIP | PPM | 13,000-25,000 |
| Fiber size | μm | 0.1-7 |

### Example 11

Multi-component fabric from a first polymer, poly-axial copolymer MX2, and a second polymer, PPD-3, with an active agent added using custom multi spinneret electrospinning enclosure and utilizes a rotating collector. The polymer/drug solution is made with HexafluoroIsopropanol (HFIP) as the solvent and targets a solution viscosity of 330-480 cP at 25° C. and shear rate of 400 s⁻¹. To achieve this viscosity, a target concentration of 7-11% polymer to solution was mixed with, or without, a 50° C. heated vessel at 50 rpm for 42 hours and tested using a viscometer.

Material was transferred to eight (8), 30-60 ml syringes and filled to a volume of 22-36 ml so that 7-16 mL could be dispensed per syringe. Using two (2), 4-channel high pressure syringe pumps the solution was then dispensed at a flow rate of 0.08-0.22 ml/min while a charge of 30 kV was applied. The material was then collected on a rotating mandrel which 236 mm away from the eight (8), 20-25 gauge needles.

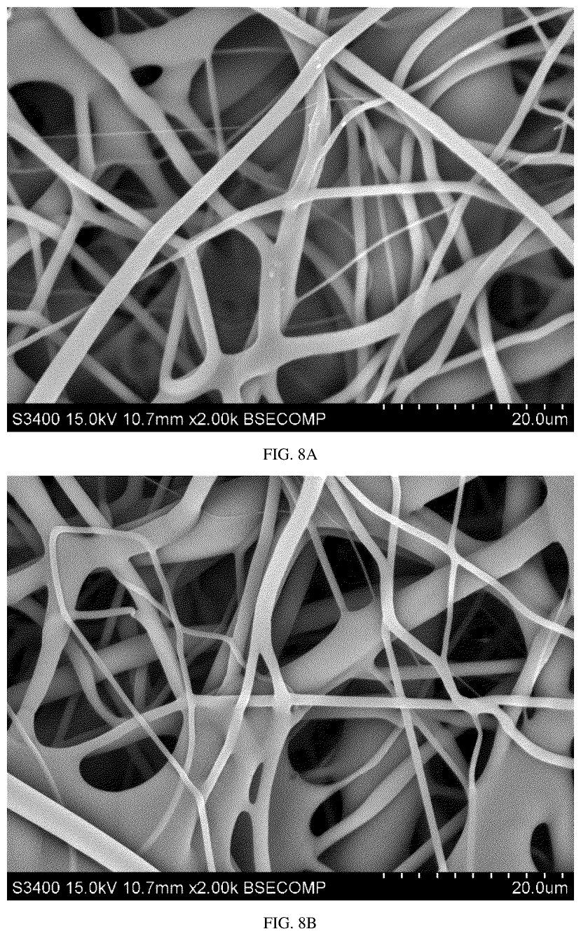

The collected material was then dried using 38° C. heated-vacuum three to five (3-5) nights and tested for suture pull out (SPO), tensile strength, burst strength, basis weight, thickness, residual HFIP using gas chromatography (GC), fiber size using scanning electron microscope (SEM) and softness. See FIGS. 8A and 8B.

TABLE 11
MX 2/PPD 3, Triclosan (2/1 ratio, 2.3 μg/m²) Material Properties

| Test | Units | Result |
|---|---|---|
| Suture Pull Out | N | 2-3 |
| Tensile Strength | N | 20-22 |
| Modulus | MPa | Not Tested |
| Burst Strength | N | Not Tested |
| Basis Weight | g/cm² | 39-42 |
| Thickness | mm | 0.1-0.11 |
| rHFIP | PPM | 16,000-22,000 |
| Fiber size | μm | 0.2-9 |

### Example 12

Single component fabric from proprietary poly-axial copolymer, RD-7, using custom multi spinneret electrospinning enclosure and utilizes a rotating collector. The polymer solution was made with HexafluoroIsopropanol (HFIP) as the solvent and targeted a solution viscosity of 100-400 cP at 25° C. and shear rate of 400 s⁻¹. To achieve this viscosity, a target concentration of 7-13% polymer to solution was mixed in a 50° C. heated vessel at 50 rpm for 42 hours and tested using a viscometer.

Material was transferred to eight (8), 60 ml syringes and filled to a volume of 54 ml so that 35-52 ml of solution could be dispensed per syringe. Using two (2), 4-channel high pressure syringe pumps the solution was then dispensed at a flow rate of 0.05-0.2 ml/min while a charge of 20-35 kV was applied. The material was then collected on a rotating mandrel 200-260 mm away from the eight (8), 20 ga needles.

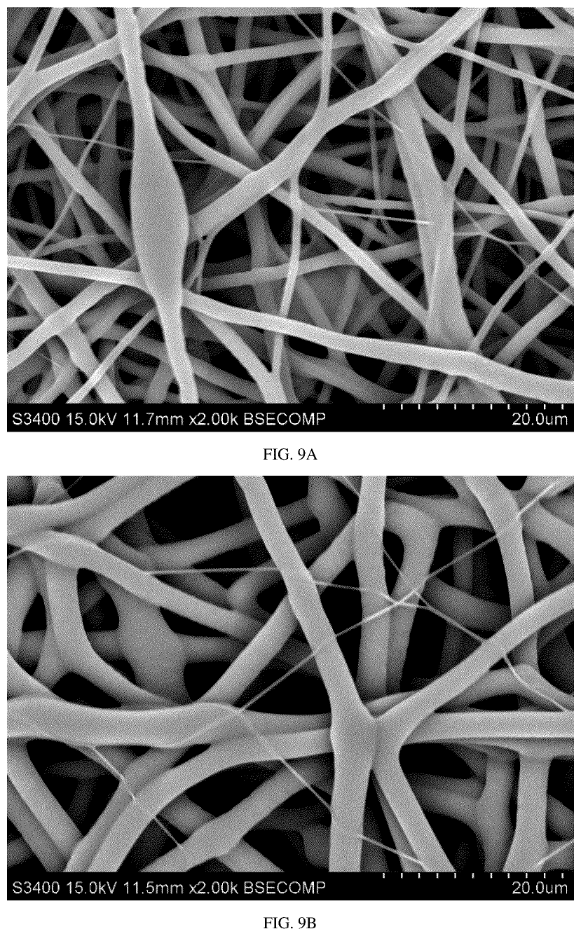

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. See FIGS. 9A and 9B.

TABLE 12
RD 7 Material Properties

| Test | Units | Result |
|---|---|---|
| Suture Pull Out | N | 7-10 |
| Tensile Strength | N | 30-50 |
| Modulus | MPa | 7-80 |
| Burst Strength | N | 50-80 |
| Basis Weight | g/cm² | 90-140 |
| Thickness | mm | 0.1-0.3 |
| rHFIP | PPM | 0-250 |
| Fiber size | μm | 0.3-8 |

### Example 13

Single component fabric from proprietary copolymer, MDP 3, using custom multi spinneret electrospinning enclosure and utilizes a rotating collector. The polymer solution was made with HexafluoroIsopropanol (HFIP) as the solvent and targeted a solution viscosity of 400-600 cP at 25° C. and shear rate of 400 s⁻¹. To achieve this viscosity, a target concentration of 6-7.5% polymer to solution was mixed in a vessel at 50 rpm for 42 hours and tested using a viscometer.

Material was transferred to eight (8), 60 ml syringes and filled to a volume of 54 ml so that 35-52 ml of solution could be dispensed per syringe. Using two (2), 4-channel high pressure syringe pumps the solution was then dispensed at a flow rate of 0.05-0.2 ml/min while a charge of 30-35 kV was applied. The material was then collected on a rotating mandrel 200-260 mm away from the eight (8), 20 ga needles.

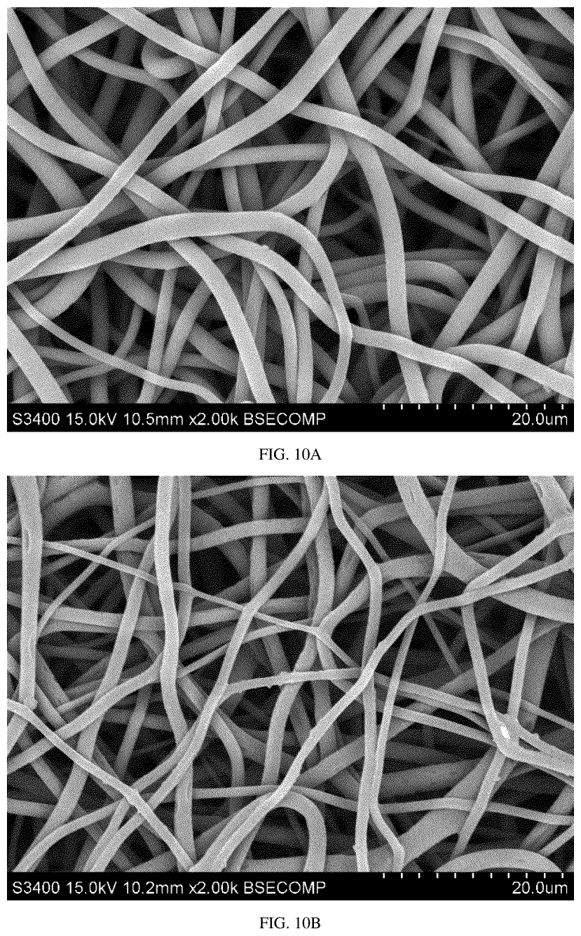

The collected material was then dried using room temperature to 70° C. vacuum overnight and tested for suture pull out (SPO), tensile strength, burst strength, basis weight, thickness, residual HFIP using gas chromatography (GC), fiber size using scanning electron microscope (SEM) and softness. See FIGS. 10A and 10B.

TABLE 13
MDP 3 Material Properties

| Test | Units | Result (predry) |
|---|---|---|
| Suture Pull Out | N | Not Tested |
| Tensile Strength | N | 30-65 |
| Modulus | MPa | 110-400 |
| Burst Strength | N | Not Tested |
| Basis Weight | g/cm² | 35-110 |
| Thickness | mm | 0.08-0.53 |
| rHFIP | PPM | 0-200 (8000) |
| Fiber size | μm | 0.3-6 |

### Example 14

Single component fabric from proprietary homopolymer, PCL, using custom multi spinneret electrospinning enclosure and utilizes a rotating collector. The polymer solution was made with HexafluoroIsopropanol (HFIP) as the solvent and targeted a solution viscosity of 400-600 cP at 25° C. and shear rate of 400 s⁻¹. To achieve this viscosity, a target concentration of 10-12% polymer to solution was mixed in a vessel at 50 rpm for 42 hours and tested using a viscometer.

Material was transferred to eight (8), 60 ml syringes and filled to a volume of 54 ml so that 7-24 ml of solution could be dispensed per syringe. Using two (2), 4-channel high pressure syringe pumps the solution was then dispensed at a flow rate of 0.1-0.2 ml/min while a charge of 25-30 kV was applied. The material was then collected on a rotating mandrel 200-260 mm away from the eight (8), 20 ga needles.

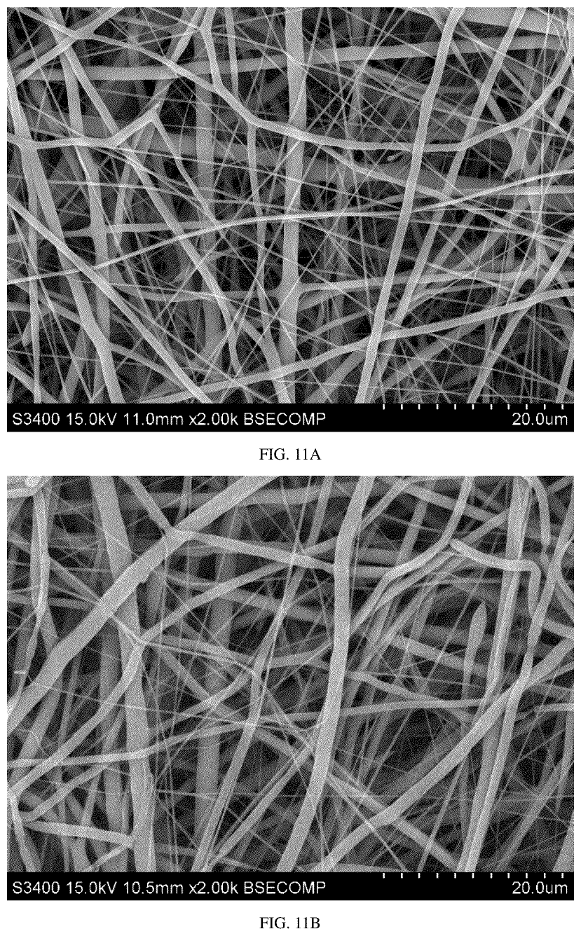

The collected material was then dried using room temperature vacuum overnight and tested for suture pull out (SPO), tensile strength, burst strength, basis weight, thickness, residual HFIP using gas chromatography (GC), fiber size using scanning electron microscope (SEM) and softness. See FIGS. 11A and 11B.

TABLE 14
PCL Material Properties

| Test | Units | Result (predry) |
|---|---|---|
| Suture Pull Out | N | Not Tested |
| Tensile Strength | N | 3-23 |
| Modulus | MPa | 1.6-9.1 |
| Burst Strength | N | Not Tested |
| Basis Weight | g/cm² | 20-65 |
| Thickness | mm | 0.2-0.6 |
| rHFIP | PPM | 0 (1000) |
| Fiber size | μm | 0.3-6 |

### Example 15

Single component fabric from proprietary homopolymer, PLA, using custom multi spinneret electrospinning enclosure and utilizes a rotating collector. The polymer solution is made with HexafluoroIsopropanol (HFIP) as the solvent and targets a solution viscosity of 400-600 cP at 25° C. and shear rate of 400 s⁻¹. To achieve this viscosity, a target concentration of 10-12% polymer to solution was mixed in a vessel at 50 rpm for 42 hours and tested using a viscometer.

Material was transferred to eight (8), 60 ml syringes and filled to a volume of 26-63 ml so that 6-58 ml of solution could be dispensed per syringe. Using two (2), 4-channel high pressure syringe pumps the solution was then dispensed at a flow rate of 0.05-0.2 ml/min while a charge of 13-35 kV was applied. The material was then collected on a rotating mandrel 200-260 mm away from the eight (8), 20 ga needles.

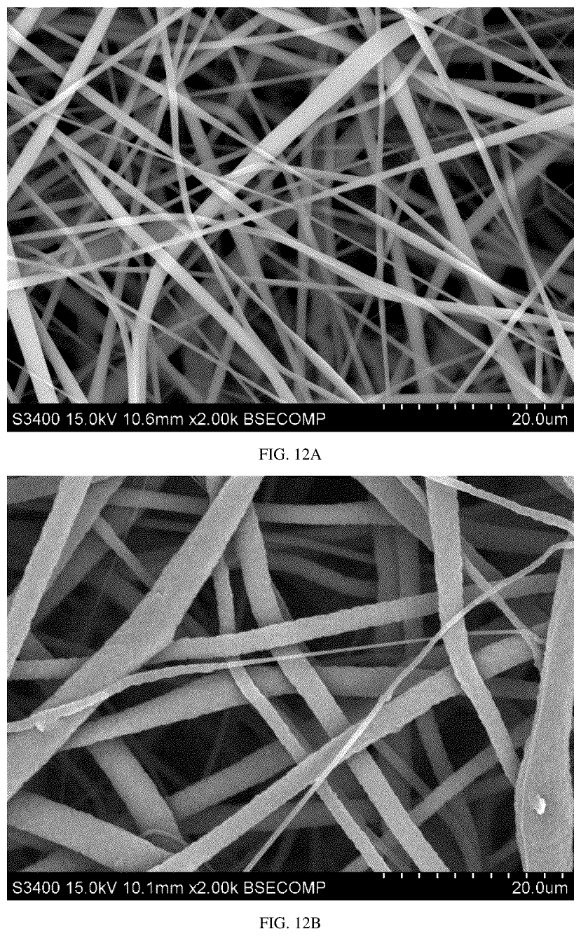

The collected material was then dried using room temperature to 70° C. vacuum overnight and tested for suture pull out (SPO), tensile strength, burst strength, basis weight, thickness, residual HFIP using gas chromatography (GC), fiber size using scanning electron microscope (SEM) and softness. See FIGS. 12A and 12B.

TABLE 15
PLA Material Properties

| Test | Units | Result (predry) |
|---|---|---|
| Suture Pull Out | N | 0.7-7 |
| Tensile Strength | N | 30-55 |
| Modulus | MPa | 170-460 |
| Burst Strength | N | 5-50 |
| Basis Weight | g/cm² | 40-111 |
| Thickness | mm | 0.09-0.64 |
| rHFIP | PPM | 0-50,000 (80,000) |
| Fiber size | μm | 0.1-8 |

### Example 16

Single component fabric from proprietary copolymer, ML-6, using custom multi spinneret electrospinning enclosure and utilizes a rotating collector. The polymer solution was made with HexafluoroIsopropanol (HFIP) as the solvent and targeted a solution viscosity of 200-600 cP at 25° C. and shear rate of 400 s⁻¹. To achieve this viscosity, a target concentration of 8-16% polymer to solution was mixed in a vessel at 50 rpm for 42 hours and tested using a viscometer.

Material was transferred to eight (8), 60 ml syringes and filled to a volume of 26-63 ml so that 6-58 ml of solution could be dispensed per syringe. Using two (2), 4-channel high pressure syringe pumps the solution was then dispensed at a flow rate of 0.1-0.3 ml/min while a charge of 13-35 kV was applied. The material was then collected on a rotating mandrel 200-260 mm away from the eight (8), 20 ga needles.

The collected material was then dried using room temperature to vacuum overnight and tested for suture pull out (SPO), tensile strength, burst strength, basis weight, thickness, residual HFIP using gas chromatography (GC), and softness.

TABLE 16
ML 6 Material Properties

| Test | Units | Result (predry) | |
|---|---|---|---|
| Suture Pull Out | N | 11 | (16) |
| Tensile Strength | N | 49 | (47) |
| Modulus | MPa | 117 | (57) |
| Burst Strength | N | 67.7 | (48.2) |
| Basis Weight | g/cm² | 201.5 | (252.7) |
| Thickness | mm | 0.748 | (0.624) |
| rHFIP | PPM | 3,823 | (106,528) |

| | | |
|---|---|---|
| Fiber size | μm | Not Tested |

### Example 17

Single component fabric from proprietary copolymer, ML 7, using custom multi spinneret electrospinning enclosure and utilizes a rotating collector. The polymer solution was made with HexafluoroIsopropanol (HFIP) as the solvent and targeted a solution viscosity of 200-600 cP at 25° C. and shear rate of 400 s⁻¹. To achieve this viscosity, a target concentration of 8-16% polymer to solution was mixed in a vessel at 50 rpm for 42 hours and tested using a viscometer.

Material was transferred to eight (8), 60 ml syringes and filled to a volume of 26-63 ml so that 6-58 ml of solution could be dispensed per syringe. Using two (2), 4-channel high pressure syringe pumps the solution was then dispensed at a flow rate of 0.05-0.3 ml/min while a charge of 13-35 kV was applied. The material was then collected on a rotating mandrel 200-260 mm away from the eight (8), 20 ga needles.

The collected material was then dried using room temperature to vacuum overnight and tested for tensile strength, thickness, residual HFIP using gas chromatography (GC), and softness.

TABLE 17
ML 7 Material Properties

| Test | Units | Result (predry) |
|---|---|---|
| Suture Pull Out | N | Not Tested |
| Tensile Strength | N | 42 |
| Modulus | MPa | 0.5-0.8 |
| Burst Strength | N | Not Tested |
| Basis Weight | g/cm² | Not Tested |
| Thickness | mm | 0.2-0.4 |
| rHFIP | PPM | (23,008) |
| Fiber size | μm | Not Tested |

### Example 18

Single component fabric from proprietary copolymer, ML 8, using custom multi spinneret electrospinning enclosure and utilizes a rotating collector. The polymer solution was made with HexafluoroIsopropanol (HFIP) as the solvent and targeted a solution viscosity of 200-600 cP at 25° C. and shear rate of 400 s⁻¹. To achieve this viscosity, a target concentration of 8-16% polymer to solution was mixed in a vessel at 50 rpm for 42 hours and tested using a viscometer.

Material was transferred to eight (8), 60 ml syringes and filled to a volume of 26-63 ml so that 6-58 ml of solution could be dispensed per syringe. Using two (2), 4-channel high pressure syringe pumps the solution was then dispensed at a flow rate of 0.05-0.3 ml/min while a charge of 13-35 kV was applied. The material was then collected on a rotating mandrel 200-260 mm away from the eight (8), 20 ga needles.

The collected material was then dried using room temperature to vacuum overnight and tested for suture pull out (SPO), tensile strength, burst strength, basis weight, thickness, residual HFIP using gas chromatography (GC), and softness.

TABLE 18
ML 8 Material Properties

| Test | Units | Result |
|---|---|---|
| Suture Pull Out | N | 10 |
| Tensile Strength | N | 50 |
| Modulus | MPa | 9.5 |
| Burst Strength | N | 48 |
| Basis Weight | g/cm² | 216 |
| Thickness | mm | 0.521 |
| rHFIP | PPM | 1,819 |
| Fiber size | μm | Not Tested |

### Example 19

Multicomponent fabric a first polymer, poly-axial copolymer MG5, and a second copolymer, ML 8, using custom multi spinneret electrospinning enclosure and utilizes a rotating collector. The polymer solutions were made with HexafluoroIsopropanol (HFIP) as the solvent and targeted a solution viscosity of 200-600 cP at 25° C. and shear rate of 400 s⁻¹. To achieve this viscosity, a target concentration of 8-16% polymer to solution was mixed in a vessel at 50 rpm for 42 hours and tested using a viscometer.

Material was transferred to eight (8), 60 ml syringes and filled to a volume of 26-63 ml so that 6-58 ml of solution could be dispensed per syringe. Using two (2), 4-channel high pressure syringe pumps the solution was then dispensed at a flow rate of 0.05-0.3 ml/min while a charge of 13-35 kV was applied. The material was then collected on a rotating mandrel 200-260 mm away from the eight (8), 20 ga needles.

The collected material was then dried using room temperature to vacuum overnight and tested for suture pull out (SPO), tensile strength, burst strength, basis weight, thickness, residual HFIP using gas chromatography (GC), and softness.

TABLE 19
MG 5/ML 8 (1/1 ratio) Material Properties

| Test | Units | Result |
|---|---|---|
| Suture Pull Out | N | 13 |
| Tensile Strength | N | 56 |
| Modulus | MPa | 12.6 |
| Burst Strength | N | 60 |
| Basis Weight | g/cm² | 226 |
| Thickness | mm | 0.625 |
| rHFIP | PPM | 1,920 |
| Fiber size | μm | Not Tested |

### Example 20

Multicomponent fabric a first polymer, poly-axial copolymer MG5, and a second copolymer, ML 8, using custom multi spinneret electrospinning enclosure and utilizes a rotating collector. The polymer solution is made with HexafluoroIsopropanol (HFIP) as the solvent and targets a solution viscosity of 200-600 cP at 25° C. and shear rate of 400 s⁻¹. To achieve this viscosity, a target concentration of 8-16% polymer to solution was mixed in a vessel at 50 rpm for 42 hours and tested using a viscometer.

Material was transferred to eight (8), 60 ml syringes and filled to a volume of 26-63 ml so that 6-58 ml of solution could be dispensed per syringe. Using one (1) to two (2), 4-channel high pressure syringe pumps the solution was then dispensed at a flow rate of 0.05-0.3 ml/min while a charge of 13-35 kV was applied. The material was then collected on a rotating mandrel 200-260 mm away from the four (4) to eight (8), 20 ga needles.

The collected material was then dried using room temperature to vacuum overnight and tested for suture pull out (SPO), tensile strength, burst strength, basis weight, thickness, residual HFIP using gas chromatography (GC), fiber size using scanning electron microscope (SEM) and softness.

TABLE 20
MG 5/ML 8 (3/1 ratio) Material Properties

| Test | Units | Result (predry) |
|---|---|---|
| Suture Pull Out | N | 7-12 |
| Tensile Strength | N | 22-49 |
| Modulus | MPa | 12.9-21.6 (2.6) |
| Burst Strength | N | 30-62 |
| Basis Weight | g/cm² | 110-213 |
| Thickness | mm | 0.31-0.635 |
| rHFIP | PPM | 2,000-8,000 |
| Fiber size | μm | Not Tested |

### Example 21

Multicomponent, drug loaded fabric a first polymer, poly-axial copolymer MG5, and a second copolymer, RD-7, and containing two active agents, Minocyline and Rifampin, using custom multi spinneret electrospinning enclosure and utilizes a rotating collector. The polymer/drug solution was made with HexafluoroIsopropanol (HFIP) as the solvent and targeted a solution viscosity of 200-600 cP at 25° C. and shear rate of 400 s⁻¹. To achieve this viscosity, a target concentration of 10-20% polymer to solution was mixed in a vessel at 50 rpm for 42 hours and tested using a viscometer.

Material was transferred to eight (8), 60 ml syringes and filled to a volume of 26-63 ml so that 6-58 ml of solution could be dispensed per syringe. Using two (2), 4-channel high pressure syringe pumps the solution was then dispensed at a flow rate of 0.05-0.3 ml/min while a charge of 13-35 kV was applied. The material was then collected on a rotating mandrel 160-260 mm away from the eight (8), 20 ga needles.

The collected material was then dried using room temperature to vacuum overnight and tested for tensile strength, thickness, and softness.

TABLE 21
MG 5/RD 7, Minocyline and Rifampin (8/3 polymer ratio, active
agents respectively 0.2 g/m² and 0.6 g/m²) Material Properties

| Test | Units | Result |
|---|---|---|
| Suture Pull Out | N | Not Tested |
| Tensile Strength | N | 40.9 |
| Modulus | MPa | 14.3 |
| Burst Strength | N | Not Tested |
| Basis Weight | g/cm² | 91.4 |
| Thickness | mm | 0.364 |
| rHFIP | PPM | Not Tested |
| Fiber size | μm | Not Tested |

### Example 22

Hydrophilic modulation of multicomponent electrospun fabric from a first polymer, poly-axial copolymer MG5, and a second homopolymer, PPD 3, and PEG (polyethylene glycol), a hydrophilic additive, using custom multi spinneret electrospinning enclosure and utilizes a rotating collector. The polymer/hydrophilic additive solutions were made with HexafluoroIsopropanol (HFIP) as the solvent and targeted a solution viscosity of 200-600 cP at 25° C. and shear rate of 400 s⁻¹. To achieve this viscosity, a target concentration of 5-20% polymer to solution was mixed with, or without, a 50° C. heated vessel at 50 rpm for 42 hours and tested using a viscometer.

Material was transferred to eight (8), 20 ml syringes and filled to a volume of 26 ml so that 15-24 ml of solution could be dispensed per syringe. Using two (2), 4-channel high pressure syringe pumps the solution was then dispensed at a flow rate of 0.05-0.3 ml/min while a charge of 13-35 kV was applied. The material was then collected on a rotating mandrel 160-260 mm away from the eight (8), 20 ga needles.

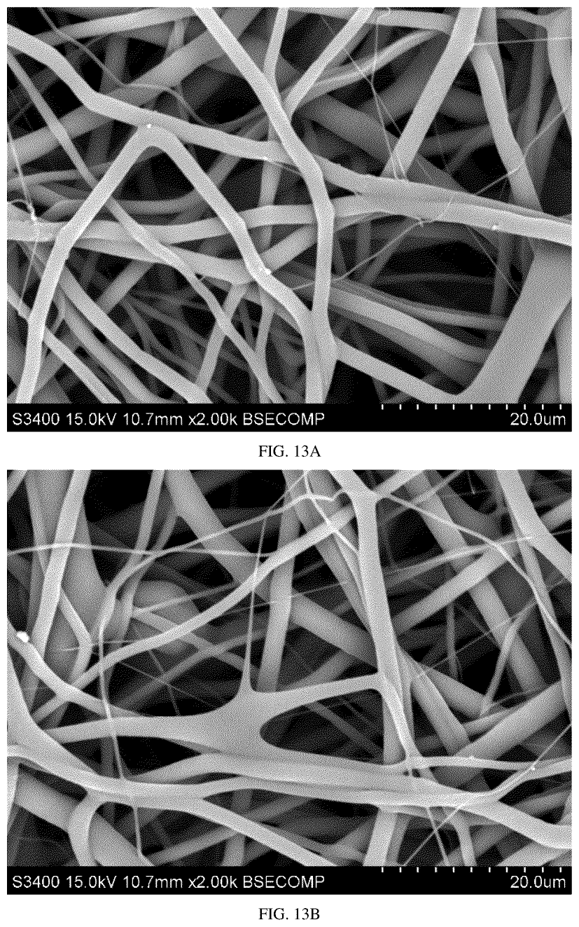

The collected material was then tested for suture pull out (SPO), tensile strength, burst strength, basis weight, thickness, residual HIP using gas chromatography (GC), fiber size using scanning electron microscope (SEM), wetting and softness. The material wettability was tested by putting a sample in room temperature water and measuring the time for it to hydrate. The sample became hydrated in 2 seconds. See FIGS. 13A and 13B.

TABLE 22
MG 5/PPD3, PEG (32/9 ratio and 1% PEG) Material Properties

| Test | Units | Result |
|---|---|---|
| Suture Pull Out | N | 3.6 |
| Tensile Strength | N | 17 |
| Modulus | MPa | 25 |
| Burst Strength | N | 25 |
| Basis Weight | g/cm² | 56 |
| Thickness | mm | 0.208 |
| rHFIP | PPM | <10,000 (pre-dry) |
| Fiber size | μm | 0.2-4.0 |

TABLE 23
Comparison of softness of provided examples

| | | Softness | | Density (kg/m³)/ | Deflection angle at |
|---|---|---|---|---|---|
| Example | Result | scale¹ | Loft² | Thickness, mm | 50 mm (degrees) |
| MG 5 | | | | | |
| Example 1 | Excellent softness | +++ | ++++ | 290/0.812 | 1 |
| | and loft | | | | |
| MG 5/RD 7 | | | | | |
| Example 3 | Excellent softness | +++ | +++ | 307/0.692 | 8.5 |
| | and loft | | | | |
| MG 5/PPD 3 | | | | | |
| Example 2 | Excellent softness | +++ | +++ | 253/0.652 | 5 |
| | and loft | | | | |
| PPD 3 | | | | | |
| Example 8 | Moderate softness | ++ | ++ | 344/0.280 | 11 |
| | and loft | | | | |
| MX 2 | | | | | |
| Example 5 | Poor softness and | + | + | 365/0.608 | |
| | loft | | | | |
| MG 9 | | | | | |
| Example 5 | Loft and poor | + | ++++ | 186/1.116 | 0 |
| | softness | | | | |
| ML 6 | | | | | |
| Example 15 | Moderate softness | ++ | ++++ | | |
| | and excellent loft | | | | |
| ML 7 | | | | | |
| Example 16 | Gelatinous softness | >++++ | + | | |
| | and poor loft | | | | |
| ML 8 | | | | | |
| Example 17 | Excellent softness | ++++ | +++ | | |
| | and moderate loft | | | | |
| MG 5/ML 8 | | | | | |
| Examples 18 | Excellent softness | | | 347/0.65 | 1 |
| and 19 | and loft | | | 334/0.35 | 20 |
| MG 5/RD 7/Drug | | | | | |
| Example 20 | Excellent softness | ++++ | ++++ | | |
| | and loft | | | | |
| MG 5/PPD3/PEG | | | | | |
| Example 21 | Excellent wetting, | +++ | +++ | 283/0.208 | 41.5 |
| | softness, and loft | | | | |

¹Softness
1+ means little softness, equals previously made electrospun material
2+ somewhat more softness
3+ more than the usual softness of an electrospun material
4+ much more softness than previous electrospun material
²Loft
1+ means little thickness, not a structurally acceptable
2+ somewhat more thickness, not a very acceptable
3+ acceptable thickness for some applications
4+ acceptable thickness, suitable for most electrospun applications

### Example 23: Pouch Forming

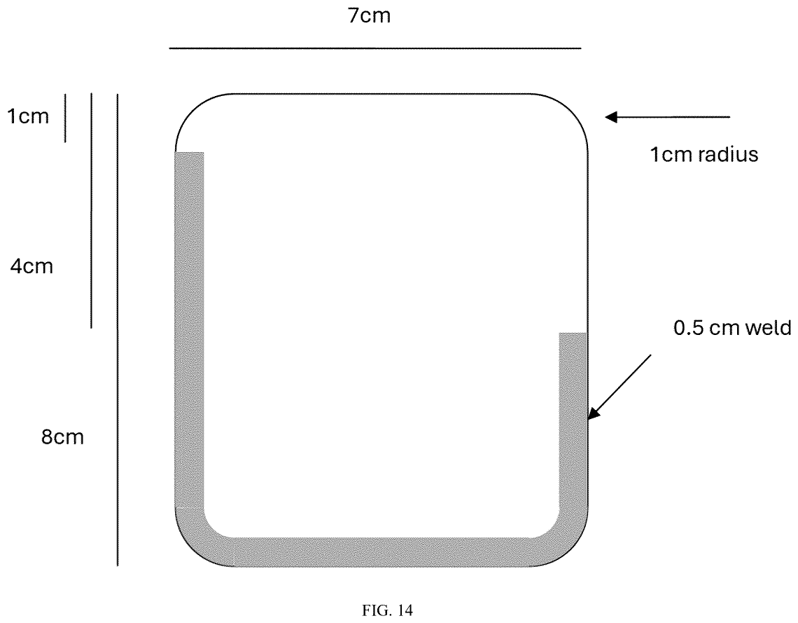

A flat electrospun fabric with thickness of 0.2 mm was laser cut into rectangles of 7.0 cm×8.0 cm, with corner radii of 1.0 cm. Cutting was accomplished using a 60-watt CO2 at 30% energy, yielding clean lines with minimal heat affected zone. Two cut rectangles were stacked and placed in an ultrasonic welder (Branson 2000Xc) and pieced together with an energy of 0.1 J/mm² to create a secure seam of 0.5 cm width around half of the rectangle, without impacting the compliance of the electrospun fabric. The welded pouch was sealed inside a foil pouch and terminally sterilized by electron beam radiation. See FIG. 14.

### Example 24: Use of Pouch to House Electronic Devices

The pouch from the earlier example is used in conjunction with a CIED implant. First, the sterile pouch is removed from its protective packaging and inspected for damage. Next, the pouch is hydrated in sterile water, saline, or lactated Ringers solution. An implantable electronic device is placed into the hydrated pouch through the unwelded opening, with the connected lead wires emerging out of the opening. The pouch containing the implant, along with the connected lead wires, are implanted into the surgically created pocket and the skin incision is closed with sutures or adhesive and a sterile bandage is applied.

### Example 25: Layered Construct Formation

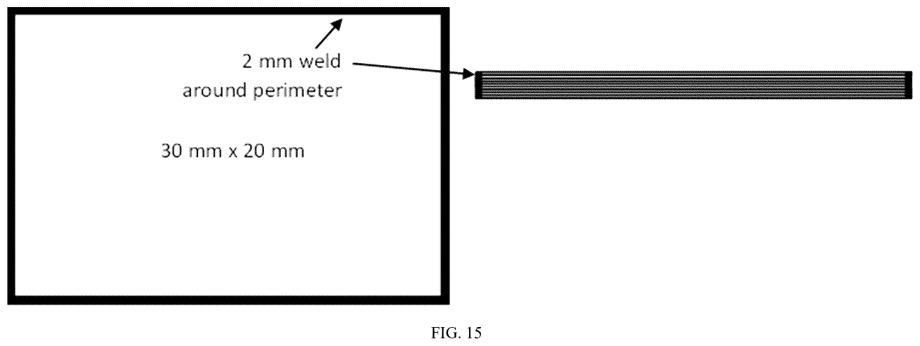

A flat electrospun fabric with thickness of 0.2 mm was cut into 20 mm×30 mm rectangles. Five pieces are stacked and placed in an ultrasonic welder (Branson 2000Xc) and pieced together with an energy of 0.2 J/mm² to create a secure seam of 2 mm width around the full perimeter of the part, without reducing the suture retention strength or mechanical strength of the layered part. See FIG. 15.

### Example 26: Use of Layered Constructs for Rotator Cuff Repair

The layered construct from the earlier example is used as part of rotator cuff repair. First, entry points are surgically created and a cannula put in place to aid implantation. The rotator cuff is repaired in typical fashion. The layered construct is introduced through a cannula, placed on top of the repaired tendon and anchored into place with surgical staples. Throughout the degradation period, the layered construct acts as a barrier between the rotator cuff and surrounding tissues. Surgical access sites are closed with sutures or adhesive, and further protected with a sterile bandage or dressing.

### EXEMPLARY ASPECTS

In view of the described compositions and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: An electrospun material comprising two fiber populations wherein one fiber population comprises polymeric fibers of a block semi-crystalline copolymer comprising at least glycolide or lactide monomer residues and second fiber population wherein the semicrystalline polymer comprises a polyester, polyether ester, or polyester carbonate, wherein the electrospun construct meets the requirements of:
a. all polymers used to prepare the first fiber population and the second fiber population have a glass transition temperature of <25° C.
b. a residual solvent of <2000 ppm
c. a tensile modulus of less than 30 MPa at room temperature
d. wettable when placed in water in under 5 sec.

Example 2: The electrospun material of any examples herein, particularly example 1, wherein the electrospun material is a triblock polymer comprising of glycolide or lactide monomers that are less than 90% of the composition and greater than 55% of the composition.

Example 3: The electrospun material of any examples herein, particularly example 1, wherein the material is a triblock polymer structure of with an amorphous segment comprising of either trimethylene carbonate or caprolactone.

Example 4: The electrospun material of any examples herein, particularly example 1, wherein the material is a triblock polymer structure with an amorphous segment comprises a glass transition temperature of less than 0° C.

Example 5: The electrospun material of any examples herein, particularly example 1, wherein the material comprise a block copolymer of an amorphous segment (A), a semicrystalline endgraft (B), and an initiator (I) wherein the structure may be I-A-B and the initiator may be monofunctional, difunctional, trifunctional, and other multifunctional moieties.

Example 6: The electrospun material of any examples herein, particularly example 1, wherein the material has a residual solvent less than 1000 ppm.

Example 7: The electrospun material of any examples herein, particularly example 1, wherein the residual solvent is less than 2000 ppm.

Example 8: The electrospun material of any examples herein, particularly example 1, wherein the material has a residual hexafluoro-2-propanol less than 1000 ppm.

Example 9: The electrospun material of any examples herein, particularly example 1, wherein the material has a residual hexafluoro-2-propanol less than 2000 ppm.

Example 10: The electrospun material of any examples herein, particularly example 1, wherein the material has a density of less than 350 kg/m³.

Example 11: The electrospun material of any examples herein, particularly example 1, wherein the material has a deflection of >1° with a 50 mm sheet.

Example 12: The electrospun material of any examples herein, particularly example 1, wherein the material has at least two fiber populations of a polyester or polyester carbonate.

Example 13: The electrospun material of any examples herein, particularly example 1, wherein the material has at least two fiber populations wherein the second fiber population comprises polydioxanone.

Example 14: The electrospun material of any examples herein, particularly example 1, wherein the material is a blend of polymers comprising polyester, polyester carbonates, polyethers, or combinations thereof.

Example 15: The electrospun material of any examples herein, particularly example 1, wherein the material comprises at least one bioactive agent selected from the group consisting of anti-inflammatory agents, anesthetic agents, antineoplastic agents, antimicrobial agents, microbicidal agents, antithrombic agents, and cell growth-promoting agents.

Example 16: The electrospun material of any examples herein, particularly example 1, wherein the material is a medical device or combinational product.

Example 17: The electrospun material of any examples herein, particularly example 1, wherein the material is a bioabsorbable pouch.

Example 18: An electrospun material, comprising polymeric fibers from a block copolymer of at least glycolide or lactide monomers wherein the electrospun material comprises:
a. a polymer glass transition temperature <25° C.
b. a residual solvent of <2000 ppm
c. a tensile modulus of less than 30 MPa at room temperature.

Example 19: The electrospun material of any examples herein, particularly example 18, wherein the electrospun material is a triblock polymer comprising of glycolide or lactide monomers that are less than 90% of the composition and greater than 55% of the composition.

Example 20: The electrospun material of any examples herein, particularly example 18, wherein the material is a triblock polymer structure of with an amorphous segment comprising of either trimethylene carbonate or caprolactone.

Example 21: The electrospun material of any examples herein, particularly example 18, wherein the material is a triblock polymer structure with an amorphous segment comprises a glass transition temperature of less than 0° C.

Example 22: The electrospun material of any examples herein, particularly example 18, wherein the material has a glass transition temperature that is less than 25° C.

Example 23: The electrospun material of any examples herein, particularly example 18, wherein the material comprise a block copolymer of an amorphous segment (A), a semicrystalline endgraft (B), and an initiator (I) wherein the structure may be I-A-B and the initiator may be monofunctional, difunctional, trifunctional, and other multifunctional moieties.

Example 24: The electrospun material of any examples herein, particularly example 18, wherein the material has a residual solvent less than 1000 ppm.

Example 25: The electrospun material of any examples herein, particularly example 18, wherein the material has a residual hexafluoro-2-propanol less than 1000 ppm.

Example 26: The electrospun material of any examples herein, particularly example 18, wherein the material has a residual hexafluoro-2-propanol less than 2000 ppm.

Example 27: The electrospun material of any examples herein, particularly example 18, wherein the material has a density of less than 350 kg/m³.

Example 28: The electrospun material of any examples herein, particularly example 18, wherein the material has a deflection of >1° with a 50 mm sheet.

Example 29: The electrospun material of any examples herein, particularly example 18, wherein the material has at least two fiber populations of a polyester or polyester carbonate.

Example 30: The electrospun material of any examples herein, particularly example 18, wherein the material has at least two fiber populations wherein the second fiber population comprises polydioxanone.

Example 31: The electrospun material of any examples herein, particularly example 18, wherein the material is a blend of polymers comprising polyester, polyester carbonates, polyethers, or combinations thereof.

Example 32: The electrospun material of any examples herein, particularly example 18, wherein the material is wettable in water at room temperature in under 5 seconds.

Example 33: The electrospun material of any examples herein, particularly example 18, wherein the material comprises at least one bioactive agent selected from the group consisting of anti-inflammatory agents, anesthetic agents, antineoplastic agents, antimicrobial agents, microbicidal agents, antithrombic agents, and cell growth-promoting agents.

Example 34: The electrospun material of any examples herein, particularly example 18, wherein the material is a medical device or combinational product.

Example 35: The electrospun material of any examples herein, particularly example 18, wherein the material is a bioabsorbable pouch.

Other advantages which are obvious and which are inherent to the various implementations described herein will be evident to one skilled in the art. It will be understood that certain features and sub-combinations are of utility and may be employed without reference to other features and sub-combinations. This is contemplated by and is within the scope of the claims. Since many possible implementations may be made of the present disclosure without departing from the scope thereof, it is to be understood that all matter herein set forth or shown in the accompanying drawings is to be interpreted as illustrative and not in a limiting sense.

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

What is claimed is:

1. An electrospun material comprising two fiber populations wherein one fiber population comprises polymeric fibers of a block semi-crystalline copolymer comprising at least glycolide or lactide monomer residues and second fiber population wherein the semicrystalline polymer comprises a polyester, polyether ester, or polyester carbonate, wherein the electrospun material meets the requirements of:
a. all polymers used to prepare the first fiber population and the second fiber population have a glass transition temperature of <25° C.;
b. a residual solvent of <2000 ppm;
c. a tensile modulus of less than 30 MPa at room temperature; and
d. wettable when placed in water in under 5 sec; and
wherein the electrospun material comprises a block copolymer of an amorphous segment (A), a semicrystalline endgraft (B), and an initiator (I) wherein the structure may be I-A-B and the initiator may be monofunctional, difunctional, trifunctional, and other multifunctional moieties.

2. The electrospun material of claim 1, wherein the electrospun material comprises a triblock polymer comprising of glycolide or lactide monomers that are less than 90% of the composition and greater than 55% of the composition.

3. The electrospun material of claim 1, wherein the electrospun material comprises a triblock polymer structure of with an amorphous segment comprising of either trimethylene carbonate or caprolactone; wherein the electrospun material comprises a triblock polymer structure with an amorphous segment comprises a glass transition temperature of less than 0° C.; or a combination thereof.

4. The electrospun material of claim 1, wherein the electrospun material has a residual solvent of less than 1000 ppm.

5. The electrospun material of claim 1, wherein the electrospun material has a density of less than 350 kg/m³; wherein the electrospun material has a deflection of ≥1° with a 50 mm sheet; or a combination thereof.

6. The electrospun material of claim 1, wherein the electrospun material has at least two fiber populations of a polyester or polyester carbonate.

7. The electrospun material of claim 1, wherein the electrospun material has at least two fiber populations wherein the second fiber population comprises polydioxanone.

8. The electrospun material of claim 1, wherein the electrospun material is a blend of polymers comprising polyester, polyester carbonates, polyethers, or combinations thereof.

9. The electrospun material of claim 1, wherein the electrospun material comprises at least one bioactive agent selected from the group consisting of anti-inflammatory agents, anesthetic agents, antineoplastic agents, antimicrobial agents, microbicidal agents, antithrombic agents, and cell growth-promoting agents.

10. The electrospun material of claim 1, wherein the electrospun material is a medical device or combinational product, or wherein the electrospun material is a bioabsorbable pouch.

11. An electrospun material, comprising polymeric fibers from a block copolymer of at least glycolide or lactide monomers wherein the electrospun material comprises:
a. a polymer glass transition temperature <25° C.;
b. a residual solvent of <2000 ppm; and
c. a tensile modulus of less than 30 MPa at room temperature; and
wherein the electrospun material comprises a block copolymer of an amorphous segment (A), a semicrystalline endgraft (B), and an initiator (I) wherein the structure may be I-A-B and the initiator may be monofunctional, difunctional, trifunctional, and other multifunctional moieties.

12. The electrospun material of claim 11, wherein the electrospun material comprises a triblock polymer comprising of glycolide or lactide monomers that are less than 90% of the composition and greater than 55% of the composition.

13. The electrospun material of claim 11, wherein the electrospun material comprises a triblock polymer structure of with an amorphous segment comprising of either trimethylene carbonate or caprolactone; wherein the electrospun material comprises a triblock polymer structure with an amorphous segment comprises a glass transition temperature of less than 0° C.; or a combination thereof.

14. The electrospun material of claim 11, wherein the electrospun material has a glass transition temperature that is less than 25° C.

15. The electrospun material of claim 11, wherein the electrospun material has a residual solvent of less than 1000 ppm.

16. The electrospun material of claim 11, wherein the electrospun material has a density of less than 350 kg/m³; wherein the electrospun material has a deflection of >1 with a 50 mm sheet; wherein the electrospun material is wettable in water at room temperature in under 5 seconds; or a combination thereof.

17. The electrospun material of claim 11, wherein the electrospun material has at least two fiber populations of a polyester or polyester carbonate.

18. The electrospun material of claim 11, wherein the electrospun material has at least two fiber populations wherein the second fiber population comprises polydioxanone.

19. The electrospun material of claim 11, wherein the electrospun material is a blend of polymers comprising polyester, polyester carbonates, polyethers, or combinations thereof.

20. The electrospun material of claim 11, wherein the electrospun material comprises at least one bioactive agent selected from the group consisting of anti-inflammatory agents, anesthetic agents, antineoplastic agents, antimicrobial agents, microbicidal agents, antithrombic agents, and cell growth-promoting agents.

21. The electrospun material of claim 11, wherein the electrospun material is a medical device or combinational product, or wherein the electrospun material is a bioabsorbable pouch.
